(19) United States
(12) Patent Application Publication
(10) Pub. No.: US 2010/0163788 A1
(43) Pub. Date: Jul. 1, 2010

(54) LIQUID CLEANER FOR THE REMOVAL OF POST-ETCH RESIDUES

(75) Inventors: Pamela Visintin, North Charleston, SC (US); Ping Jiang, Danbury, CT (US); Michael B. Korzenski, Danbury, CT (US); David W. Minsek, New Milford, CT (US); Emanuel I. Cooper, Scarsdale, NY (US); Ming-Ann Hsu, Taipei (TW); Kristin A. Fletcher, New Milford, CT (US)

Correspondence Address: MOORE & VAN ALLEN PLLC, P.O. BOX 13706, Research Triangle Park, NC, 27709, US

(73) Assignee: ADVANCED TECHNOLOGY MATERIALS, INC., Danbury, CT (US)

(21) Appl. No.: 12/520,121

(22) PCT Filed: Dec. 21, 2007
(86) PCT No.: PCT/US07/88644

§ 371 Date: Feb. 8, 2010

Related U.S. Application Data
(60) Provisional application No. 60/871,362, filed on Dec. 21, 2006.
(60) Provisional application No. 60/886,830, filed on Jan. 26, 2007.
(60) Provisional application No. 60/895,302, filed on Mar. 16, 2007.
(60) Provisional application No. 60/947,178, filed on Jun. 29, 2007.

(51) Int. Cl. C09K 13/08; C09K 13/00

(52) U.S. Cl. 252/79.3; 252/79.1

(57) ABSTRACT

Cleaning compositions and processes for cleaning post-plasma etch residue from a microelectronic device having said residue thereon. The composition achieves highly efficacious cleaning of the residue material, including titanium-containing, copper-containing, tungsten-containing, and/or cobalt-containing post-etch residue from the microelectronic device while simultaneously not damaging the interlevel dielectric, metal interconnect material, and/or capping layers also present thereon. In addition, the composition may be useful for the removal of titanium nitride layers from a microelectronic device having same thereon.

### FIELD OF THE INVENTION

The present invention relates to compositions for the removal of post-etch residue, including titanium-containing, copper-containing and/or tungsten-containing post-etch residue, from microelectronic devices and methods of making and using the same.

### DESCRIPTION OF THE RELATED ART

Interconnect circuitry in semiconductor circuits consists of conductive metallic circuitry surrounded by insulating dielectric material. In the past, silicate glass vapor-deposited from tetraethylorthosilicate (TEOS) was widely used as the dielectric material, while alloys of aluminum were used for metallic interconnects. Demand for higher processing speeds has led to smaller sizing of circuit elements, along with the replacement of TEOS and aluminum alloys by higher performance materials. Aluminum alloys have been replaced by copper or copper alloys due to the higher conductivity of copper. TEOS and fluorinated silicate glass (FSG) have been replaced by the so-called low-k dielectrics, including low-polarity materials such as organic polymers, hybrid organic/inorganic materials, organosilicate glass (OSG), and carbon-doped oxide (CDO) glass. The incorporation of porosity, i.e., air-filled pores, in these materials further lowers the dielectric constant of the material.

During dual-damascene processing of integrated circuits, photolithography is used to image a pattern onto a device wafer. Photolithography techniques comprise the steps of coating, exposure, and development. A wafer is coated with a positive or negative photoresist substance and subsequently covered with a mask that defines patterns to be retained or removed in subsequent processes. Following the proper positioning of the mask, the mask has directed therethrough a beam of monochromatic radiation, such as ultraviolet (UV) light or deep UV (DUV) light (≈250 nm or 193 nm), to make the exposed photoresist material more or less soluble in a selected rinsing solution. The soluble photoresist material is then removed, or “developed,” leaving behind a pattern identical to the mask.

Thereafter, gas-phase plasma etching is used to transfer the patterns of the developed photoresist coating to the underlying layers, which may include hardmask, interlevel dielectric (ILD), and/or etch stop layers. Post-plasma etch residues are typically deposited on the back-end-of-the-line (BEOL) structures and if not removed, may interfere with subsequent silicidation or contact formation. Post-plasma etch residues typically include chemical elements present on the substrate and in the plasma gases. For example, if a TiN hardmask is employed, e.g., as a capping layer over ILD, the post-plasma etch residues include titanium-containing species, which are difficult to remove using conventional wet cleaning chemistries. Moreover, conventional cleaning chemistries often damage the ILD, absorb into the pores of the ILD thereby increasing the dielectric constant, and/or corrode the metal structures. For example, buffered fluoride and solvent-based chemistries fail to completely remove Ti-containing residues, while hydroxylamine-containing and ammonia-peroxide chemistries corrode copper.

In addition to the desirable removal of titanium-containing post-plasma etch residue, additional materials that are deposited during the post-plasma etch process such as polymeric residues on the sidewalls of the patterned device, copper-containing residues in the open via structures of the device, and tungsten-containing residues are also preferably removed. To date, no single wet cleaning composition has successfully removed all of residue material while simultaneously being compatible with the ILD, other low-k dielectric materials, and metal interconnect materials.

The integration of new materials, such as low-k dielectrics, into microelectronic devices places new demands on cleaning performance. At the same time, shrinking device dimensions reduce the tolerance for changes in critical dimensions and damage to device elements. Etching conditions can be modified in order to meet the demands of the new materials. Likewise, post-plasma etch cleaning compositions must be modified. Importantly, the cleaner should not damage the underlying dielectric material or corrode metallic interconnect materials, e.g., copper, tungsten, cobalt, aluminum, ruthenium, titanium and nitrides and silicides thereof, on the device.

Towards that end, it is an object of the present invention to provide improved compositions for the effective removal of post-plasma etch residue including, but not limited to, titanium-containing residue, polymeric sidewall residue, copper-containing via residue, tungsten-containing residue, and/or cobalt-containing residue from microelectronic devices, said compositions being compatible with ILD, metal interconnect materials, and/or capping layers.

### SUMMARY OF THE INVENTION

The present invention generally relates to cleaning compositions and methods of making and using same. One aspect of the invention relates to a composition and process for cleaning post-plasma etch residue from microelectronic devices having said residue thereon, while simultaneously not compromising the metallic and ILD materials on the microelectronic device surface.

In one aspect, the present invention relates to an aqueous cleaning composition, comprising at least one etchant, at least one chelating agent, and water, optionally at least one organic solvent, optionally at least one corrosion inhibitor, optionally at least one low-k passivating agent, optionally at least one surfactant, and optionally a source of silica, wherein said aqueous cleaning composition is suitable for cleaning material from a microelectronic device having said material thereon. The material may include post-plasma etch residue, TiN layers, post-CMP residue, and combinations thereof.

In another aspect, the present invention relates to an aqueous cleaning composition, comprising fluorosilicic acid, at least one chelating agent, and water, wherein the amount of water is less than about 75 wt. %, based on the total weight of the composition, and wherein said aqueous cleaning composition is suitable for cleaning post-plasma etch residue from a microelectronic device having said residue thereon.

In still another aspect, the invention relates to an aqueous cleaning composition, comprising at least one etchant, at least one metal corrosion inhibitor, and water, optionally at least one organic solvent, optionally at least one metal chelating agent, optionally at least one low-k passivating agent, optionally at least one surfactant, and optionally a source of silica, wherein said aqueous cleaning composition is suitable for cleaning material from a microelectronic device having said material thereon. The material may include post-plasma etch residue, TiN layers, post-CMP residue, and combinations thereof.

In another aspect, the present invention relates to an aqueous cleaning composition, comprising fluorosilicic acid, at least one metal corrosion inhibitor, and water, wherein the amount of water is less than about 75 wt. %, based on the total weight of the composition, and wherein said aqueous cleaning composition is suitable for cleaning post-plasma etch residue from a microelectronic device having said residue thereon.

In still another aspect, the invention relates to an aqueous cleaning composition, comprising at least one etchant, at least one organic solvent, and water, optionally at least one metal corrosion inhibitor, optionally at least one metal chelating agent, optionally at least one low-k passivating agent, optionally at least one surfactant, and optionally a source of silica, wherein said aqueous cleaning composition is suitable for cleaning material from a microelectronic device having said material thereon. The material may include post-plasma etch residue, TiN layers, post-CMP residue, and combinations thereof.

In still another aspect, the present invention relates to an aqueous cleaning composition, comprising at least one etchant source, at least one organic solvent, at least one chelating agent, at least one metal corrosion inhibitor, and water, wherein said aqueous cleaning composition is suitable for cleaning post-plasma etch residue from a microelectronic device having said residue thereon.

In yet another aspect, the present invention relates to an aqueous cleaning composition, comprising fluorosilicic acid, at least one organic solvent, at least one chelating agent, at least one metal corrosion inhibitor, and water, wherein the amount of water is less than about 75 wt. %, based on the total weight of the composition, and wherein said aqueous cleaning composition is suitable for cleaning post-plasma etch residue from a microelectronic device having said residue thereon.

Another aspect of the invention relates to an aqueous cleaning composition comprising at least one organic solvent, at least one etchant, at least one chelating agent, a source of silica, at least one corrosion inhibitor and water, wherein the weight percent ratios of the organic solvent(s) relative to etchant(s) is about 5 to about 8, the water relative to etchant(s) is about 85 to about 91, the source of silica relative to etchant(s) is about 0.1 to about 0.5, the chelating agent(s) relative to etchant(s) is about 0.5 to about 2.5, and the corrosion inhibitor(s) relative to etchant(s) is about 1 to about 4.

Still another aspect of the invention relates to an aqueous cleaning composition comprising at least one organic solvent, at least one etchant, a source of silica, at least one corrosion inhibitor, and water, wherein the weight percent ratios of the organic solvent(s) relative to etchant(s) is about 3 to about 7, the water relative to etchant(s) is about 88 to about 93, the source of silica relative to etchant(s) is about 0.1 to about 0.5, and the corrosion inhibitor(s) relative to etchant(s) is about 1 to about 4.

Another aspect of the invention relates to an aqueous cleaning composition comprising at least one organic solvent, at least one etchant, at least one corrosion inhibitor, and water, wherein the weight percent ratios of the organic solvent(s) relative to the etchant(s) is about 60 to about 90, the water relative to etchant(s) is about 2 to about 30, and the corrosion inhibitor(s) relative to etchant(s) is about 0.01 to about 0.5.

Yet another aspect of the invention relates to a cleaning composition comprising at least one organic solvent, at least one metal-chelating agent, optionally at least one surfactant, optionally at least one corrosion inhibitor, optionally at least one low-k passivating agent, optionally at least one etchant, and optionally water, wherein said cleaning composition is suitable for cleaning material from a microelectronic device having said material thereon. The material may include post-plasma etch residue, post-CMP residue, and combinations thereof.

In still another aspect, the present invention relates to a cleaning composition, comprising, at least one organic solvent, at least one metal-chelating agent, at least one corrosion inhibitor and water, wherein said cleaning composition is suitable for cleaning post-plasma etch residue from a microelectronic device having said residue thereon.

In yet another aspect, the present invention relates to a cleaning composition comprising at least one organic solvent and at least one metal-chelating agent, wherein said cleaning composition is suitable for cleaning post-plasma etch residue from a microelectronic device having said residue thereon.

In still another aspect, the present invention relates to a cleaning composition consisting of at least one organic solvent and at least one metal-chelating agent, wherein said cleaning composition is suitable for cleaning post-plasma etch residue from a microelectronic device having said residue thereon.

Another aspect of the invention relates to a kit comprising, in one or more containers, one or more of the following reagents for forming an aqueous cleaning composition, said one or more reagents selected from the group consisting of at least one etchant, water, optionally at least one low-k passivating agent, optionally at least one surfactant, and optionally a source of silica, wherein the composition is further characterized by including components (I), (II) or (III):
(I) at least one chelating agent, optionally at least one organic solvent, and optionally at least one corrosion inhibitor;
(II) at least one metal corrosion inhibitor, optionally at least one organic solvent, and optionally at least one metal chelating agent; or
(III) at least one organic solvent, optionally at least one chelating agent, and optionally at least one corrosion inhibitor,
   and wherein the kit is adapted to form an aqueous cleaning composition suitable for cleaning post-plasma etch residue from a microelectronic device having said residue thereon.

Still another aspect of the invention relates to a kit comprising, in one or more containers, one or more of the following reagents for forming a cleaning composition, said one or more reagents selected from the group consisting of at least one organic solvent, at least one metal-chelating agent, optionally at least one surfactant, optionally at least one corrosion inhibitor, optionally at least one low-k passivating agent, optionally at least one etchant, and optionally water, and wherein the kit is adapted to form an aqueous cleaning composition suitable for cleaning post-plasma etch residue from a microelectronic device having said residue thereon.

Still another aspect of the invention relates to a method of removing post-plasma etch residue from a microelectronic device having said residue thereon, said method comprising contacting the microelectronic device with an aqueous cleaning composition for sufficient time to at least partially remove said residue from the microelectronic device, wherein the aqueous cleaning composition includes at least one etchant, at least one chelating agent, and water, optionally at least one organic solvent, optionally at least one corrosion inhibitor, optionally at least one low-k passivating agent, optionally at least one surfactant, and optionally a source of silica.

Yet another aspect of the invention relates to a method of removing post-plasma etch residue from a microelectronic device having said residue thereon, said method comprising contacting the microelectronic device with an aqueous cleaning composition for sufficient time to at least partially remove said residue from the microelectronic device, wherein the aqueous cleaning composition includes at least one etchant, at least one metal corrosion inhibitor, and water, optionally at least one organic solvent, optionally at least one metal chelating agent, optionally at least one low-k passivating agent, optionally at least one surfactant, and optionally a source of silica.

Another aspect of the invention relates to a method of removing post-plasma etch residue from a microelectronic device having said residue thereon, said method comprising contacting the microelectronic device with an aqueous cleaning composition for sufficient time to at least partially remove said residue from the microelectronic device, wherein the aqueous cleaning composition includes at least one etchant, at least one organic solvent, and water, optionally at least one chelating agent, optionally at least one corrosion inhibitor, optionally at least one low-k passivating agent, optionally at least one surfactant, and optionally a source of silica.

Another aspect of the invention relates to a method of removing post-plasma etch residue from a microelectronic device having said residue thereon, said method comprising contacting the microelectronic device with an aqueous cleaning composition for sufficient time to at least partially remove said residue from the microelectronic device, wherein the aqueous cleaning composition includes at least one etchant source, at least one organic solvent, at least one chelating agent, at least one metal corrosion inhibitor, and water.

A further aspect of the invention relates to a method of removing post-plasma etch residue from a microelectronic device having said residue thereon, said method comprising contacting the microelectronic device with a cleaning composition for sufficient time to at least partially remove said residue from the microelectronic device, wherein the cleaning composition includes at least one organic solvent, at least one metal-chelating agent, optionally at least one surfactant, optionally at least one corrosion inhibitor, optionally at least one low-k passivating agent, optionally at least one etchant, and optionally water.

In yet another aspect, the present invention relates to a method of removing post-plasma etch residue from a microelectronic device having said residue thereon, said method comprising contacting the microelectronic device with a cleaning composition for sufficient time to at least partially remove said residue from the microelectronic device, wherein the cleaning composition includes at least one organic solvent and at least one chelating agent.

Another aspect of the invention relates to an article of manufacture comprising an aqueous cleaning composition of the invention, a microelectronic device, and post-plasma etch residue.

In a further aspect, the present invention relates to a method of manufacturing a microelectronic device, said method comprising contacting the microelectronic device with an aqueous cleaning composition of the invention for sufficient time to at least partially remove post-plasma etch residue from the microelectronic device having said residue thereon.

Another aspect of the invention relates to an article of manufacture comprising a cleaning composition of the invention, a microelectronic device including an ultra low-k dielectric layer, and post-plasma etch residue.

In a further aspect, the present invention relates to a method of manufacturing a microelectronic device, said method comprising contacting the microelectronic device with a cleaning cleaning composition of the invention for sufficient time to at least partially remove post-plasma etch residue from the microelectronic device having said residue thereon.

Another aspect of the invention relates to a method of removing TiOF crystals from a microelectronic device having same thereon, said method comprising contacting the microelectronic device with an aqueous cleaning composition for sufficient time to at least partially remove said TiOF crystals from the microelectronic device, wherein the aqueous cleaning composition comprises at least one organic solvent, at least one etchant, a source of silica, at least one tungsten corrosion inhibitor, and water.

Yet another aspect of the invention relates to improved microelectronic devices, and products incorporating same, made using the methods of the invention comprising cleaning of post-plasma etch residue from the microelectronic device having said residue thereon, using the methods and/or compositions described herein, and optionally, incorporating the microelectronic device into a product.

Other aspects, features and advantages of the invention will be more fully apparent from the ensuing disclosure and appended claims.

### BRIEF DESCRIPTION OF THE DRAWINGS

FIG. 1 is an FTIR spectrum of a blanketed ULK wafer before and after cleaning the wafer with formulation A of the present invention.

FIG. 2 is an FTIR spectrum of a blanketed ULK wafer before and after cleaning the wafer with formulation B of the present invention.

FIGS. 3A and 3B are micrographs of a blanketed CoWP wafer before (3A) and after (3B) immersion in formulation AB for 2 hr at 50° C.

### DETAILED DESCRIPTION OF THE INVENTION, AND PREFERRED EMBODIMENTS THEREOF

The present invention relates to compositions for removing residue, preferably post-etch residue, more preferably titanium-containing post-etch residue, polymeric sidewall residue, copper-containing via and line residue and/or tungsten-containing post-etch residue from microelectronic devices having said residue thereon, said compositions preferably being compatible with ultra low-k (ULK) ILD materials, such as OSG and porous-CDO, the metallic interconnect materials, e.g., copper and tungsten, the hardmask capping layers, e.g., TiN, and cobalt capping layers, e.g., CoWP, on the microelectronic device surface. Further, the present invention relates to methods of removing residue, preferably post-etch residue, more preferably titanium-containing post-etch residue, polymeric sidewall residue, copper-containing via and line residue, tungsten-containing post-etch residue, and/or cobalt-containing post-etch residue, from microelectronic devices having said residue thereon, using compositions, said compositions preferably being compatible with ultra low-k (ULK) ILD materials, the metallic interconnect materials, and the capping layers, on the microelectronic device surface.

For ease of reference, “microelectronic device” corresponds to semiconductor substrates, flat panel displays, and microelectromechanical systems (MEMS), manufactured for use in microelectronic, integrated circuit, or computer chip applications. It is to be understood that the term “microelectronic device” is not meant to be limiting in any way and includes any substrate that will eventually become a microelectronic device or microelectronic assembly. Notably, the microelectronic device substrate may be patterned, blanketed and/or a test substrate.

“Post-etch residue” and “post-plasma etch residue,” as used herein, corresponds to material remaining following gas-phase plasma etching processes, e.g., BEOL dual-damascene processing. The post-etch residue may be organic, organometallic, organosilicic, or inorganic in nature, for example, silicon-containing material, titanium-containing material, nitrogen-containing material, oxygen-containing material, polymeric residue material, copper-containing residue material (including copper oxide residue), tungsten-containing residue material, cobalt-containing residue material, etch gas residue such as chlorine and fluorine, and combinations thereof.

As defined herein, “low-k dielectric material” and ULK corresponds to any material used as a dielectric material in a layered microelectronic device, wherein the material has a dielectric constant less than about 3.5. Preferably, the low-k dielectric materials include low-polarity materials such as silicon-containing organic polymers, silicon-containing hybrid organic/inorganic materials, organosilicate glass (OSG), TEOS, fluorinated silicate glass (FSG), silicon dioxide, and carbon-doped oxide (CDO) glass. Most preferably, the low-k dielectric material is deposited using organosilane and/or organosiloxane precursors. It is to be appreciated that the low-k dielectric materials may have varying densities and varying porosities.

As defined herein, the term “polymeric sidewall residue” corresponds to the residue that remains on the sidewalls of the patterned device subsequent to post-plasma etching processes. The residue is substantially polymeric in nature however, it should be appreciated that inorganic species, e.g., titanium, silicon, tungsten, cobalt and/or copper-containing species, may be present in the sidewall residue as well.

As used herein, “about” is intended to correspond to ±5% of the stated value.

As used herein, “suitability” for cleaning post-etch residue from a microelectronic device having said residue thereon corresponds to at least partial removal of said residue from the microelectronic device. Preferably, at least about 90% of one or more of the materials, more preferably at least 95% of one or more of the materials, and most preferably at least 99% of one or more of the materials to be removed are removed from the microelectronic device.

“Capping layer” as used herein corresponds to materials deposited over dielectric material and/or metal material, e.g., cobalt, to protect same during the plasma etch step. Hardmask capping layers are traditionally silicon, silicon nitrides, silicon oxynitrides, titanium nitride, titanium oxynitride, titanium, tantalum, tantalum nitride, molybdenum, tungsten, combinations thereof, and other similar compounds. Cobalt capping layers include CoWP and other cobalt-containing materials or tungsten-containing materials.

“Substantially devoid” is defined herein as less than 2 wt. %, preferably less than 1 wt. %, more preferably less than 0.5 wt. %, and most preferably less than 0.1 wt. %.

As used herein, the term “semi-aqueous” refers to a mixture of water and organic components. “Non-aqueous” refers to a composition that is substantially devoid of water.

Compositions of the invention may be embodied in a wide variety of specific formulations, as hereinafter more fully described.

In all such compositions, wherein specific components of the composition are discussed in reference to weight percentage ranges including a zero lower limit, it will be understood that such components may be present or absent in various specific embodiments of the composition, and that in instances where such components are present, they may be present at concentrations as low as 0.001 weight percent, based on the total weight of the composition in which such components are employed.

Titanium-containing post-etch residue materials are notoriously difficult to remove using the ammonia-containing compositions of the prior art. The present inventors discovered a cleaning composition that is substantially devoid of ammonia and/or strong bases (e.g., NaOH, KOH, etc.) and preferably, substantially devoid of oxidizing agents, which effectively and selectively removes titanium-containing residues from the surface of a microelectronic device having same thereon. In addition, the composition will substantially remove polymeric sidewall residue, copper-containing residue, cobalt-containing residue, and/or tungsten-containing residue without substantially damaging the underlying ILD, metal interconnect materials, e.g., Cu, Al, Co and W, and/or the capping layers. Further, the compositions may be used regardless of whether the trench or via is etched first (i.e., a trench-first or via-first scheme). Importantly, some compositions of the invention effectively etch TiN layers, when desired.

In a first aspect, the cleaning compositions of the invention are aqueous or semi-aqueous and include at least one etchant source, at least one metal-chelating agent, water, optionally at least one organic solvent, optionally at least one corrosion inhibitor, optionally at least one low-k passivating agent, optionally at least one surfactant, and optionally a source of silica, for removing post-plasma etch residues from the surface of a microelectronic device having same thereon, wherein the post-plasma etch residue comprises a species selected from the group consisting of titanium-containing residues, polymeric residues, copper-containing residues, tungsten-containing residues, cobalt-containing residues, and combinations thereof. In another embodiment, the cleaning compositions of the invention include fluorosilicic acid, at least one metal-chelating agent, and water. In yet another embodiment, the cleaning compositions of the invention include at least one etchant source, at least one metal corrosion inhibitor, water, optionally at least one organic solvent, optionally at least one chelating agent, optionally at least one low-k passivating agent, optionally at least one surfactant, and optionally a source of silica. In still another embodiment, the cleaning compositions of the invention include fluorosilicic acid, at least one metal corrosion inhibitor, and water. In still another embodiment, the cleaning compositions of the invention include at least one etchant source, at least one organic solvent, at least one metal-chelating agent, and water. In another embodiment, the cleaning compositions of the invention include fluorosilicic acid, at least one organic solvent, at least one metal-chelating agent, and water. In still another embodiment, the cleaning compositions of the invention include at least one etchant source, at least one organic solvent, at least one metal corrosion inhibitor, and water. In yet another embodiment, the cleaning compositions of the invention include fluorosilicic acid, at least one organic solvent, at least one metal corrosion inhibitor, and water. In another embodiment, the cleaning compositions of the invention include at least one etchant source, at least one organic solvent, at least one metal-chelating agent, at least one metal corrosion inhibitor, and water. In still another embodiment, the cleaning compositions of the invention include fluorosilicic acid, at least one organic solvent, at least one metal-chelating agent, at least one metal corrosion inhibitor, and water. In each embodiment, at least one surfactant may be added. In still another embodiment, the cleaning compositions of the invention include at least one etchant source, at least one organic solvent, at least one metal-chelating agent, at least one metal corrosion inhibitor, dissolved silica, and water. In still another embodiment, the cleaning compositions of the invention include fluorosilicic acid, at least one organic solvent, at least one metal-chelating agent, at least one metal corrosion inhibitor, dissolved silica, and water. In still another embodiment, the cleaning compositions of the invention include at least one etchant source, at least one organic solvent, at least one metal corrosion inhibitor, dissolved silica, and water. In still another embodiment, the cleaning compositions of the invention include fluorosilicic acid, at least one organic solvent, at least one metal corrosion inhibitor, dissolved silica, and water. In another embodiment, the cleaning compositions of the invention include at least one etchant, at least one organic solvent, at least one low-k passivating agent, at least one corrosion inhibitor and water. In yet another embodiment, the cleaning composition of the invention includes at least one etchant, at least one organic solvent, water, optionally at least one chelating agent, optionally at least one corrosion inhibitor, optionally at least one low-k passivating agent, optionally at least one surfactant and optionally at least one silica source.

In one embodiment of the first aspect, the present invention relates to an aqueous composition for cleaning post-plasma etch residues selected from the group consisting of titanium-containing residues, polymeric residues, copper-containing residues, tungsten-containing residues, cobalt-containing residues, and combinations thereof, said composition including at least one etchant source, at least one chelating agent, water, optionally at least one organic solvent, optionally at least one metal corrosion inhibitor, optionally at least one low-k passivating agent, optionally a source of silica, and optionally at least one surfactant, present in the following ranges, based on the total weight of the composition.

| component | % by weight |
|---|---|
| etchant source(s) | about 0.05% to about 20% |
| chelating agent(s) | about 0.5% to about 30% |
| water | about 50% to about 97% |
| organic solvent | 0% to about 50 wt. % |
| metal corrosion inhibitor(s) | 0% to about 10% |
| surfactant(s) | 0 to about 10% |
| low-k passivating agent(s) | 0 to about 10% |
| silica source | 0 to about 5% |

In another embodiment of the first aspect, the present invention relates to an aqueous composition for cleaning post-plasma etch residues selected from the group consisting of titanium-containing residues, polymeric residues, copper-containing residues, tungsten-containing residues, cobalt-containing residues, and combinations thereof, said composition including at least one etchant source, at least one corrosion inhibitor, water, optionally at least one organic solvent, optionally at least one chelating agent, optionally at least one low-k passivating agent, optionally a source of silica, and optionally at least one surfactant, present in the following ranges, based on the total weight of the composition.

| component | % by weight |
|---|---|
| etchant source(s) | about 0.05% to about 20% |
| corrosion inhibitor(s) | about 0.01% to about 10% |
| water | about 30% to about 97% |
| organic solvent | 0% to about 50 wt. % |
| metal chelating agent(s) | 0% to about 30% |
| surfactant(s) | 0 to about 10% |
| low-k passivating agent(s) | 0 to about 10% |
| silica source | 0 to about 5% |

In yet another embodiment of the first aspect, the present invention relates to an aqueous composition for cleaning post-plasma etch residues selected from the group consisting of titanium-containing residues, polymeric residues, copper-containing residues, tungsten-containing residues, cobalt-containing residues, and combinations thereof, said composition including at least one etchant source, at least one organic solvent, water, optionally at least one corrosion inhibitor, optionally at least one chelating agent, optionally at least one low-k passivating agent, optionally a source of silica, and optionally at least one surfactant, present in the following ranges, based on the total weight of the composition.

| component | % by weight |
|---|---|
| etchant source(s) | about 0.05% to about 20% |
| organic solvent | about 2% to about 45% |
| water | about 50% to about 97% |
| corrosion inhibitor(s) | 0% to about 30 wt. % |
| metal chelating agent(s) | 0% to about 30% |
| surfactant(s) | 0 to about 10% |
| low-k passivating agent(s) | 0 to about 10% |
| silica source | 0 to about 5% |

Notably, the weight percent of the at least one etchant includes “neat” etchant or alternatively, the amount of the propylene glycol/etchant mixture, regardless of the weight ratio of propylene glycol to etchant. It is to be appreciated by one skilled in the art that the weight percent of etchant in the cleaning composition is less than the weight percent of the PG/etchant component added to the cleaning composition. For example, the weight percent of HF in the cleaning composition including 0.5 wt. % PG/HF (96:4) mixture is actually 0.02 wt. %.

In the broad practice of the invention, the cleaning composition of the first aspect may comprise, consist of, or consist essentially of: (i) at least one etchant source, at least one metal-chelating agent, and water; (ii) fluorosilicic acid, at least one metal-chelating agent, and water; (iii) at least one etchant source, at least one metal corrosion inhibitor, and water; (iv) fluorosilicic acid, at least one metal corrosion inhibitor, and water; (v) at least one etchant source, at least one organic solvent, at least one metal-chelating agent, and water; (vi) fluorosilicic acid, at least one organic solvent, at least one metal-chelating agent, and water; (vii) at least one etchant source, at least one organic solvent, at least one metal corrosion inhibitor, and water; (viii) fluorosilicic acid, at least one organic solvent, at least one metal corrosion inhibitor, and water; (ix) at least one etchant source, at least one organic solvent, at least one metal-chelating agent, at least one metal corrosion inhibitor, and water; (x) fluorosilicic acid, at least one organic solvent, at least one metal-chelating agent, at least one metal corrosion inhibitor, and water; (xi) at least one etchant source, at least one organic solvent, at least one metal-chelating agent, at least one metal corrosion inhibitor, dissolved silica, and water; (xii) fluorosilicic acid, at least one organic solvent, at least one metal-chelating agent, at least one metal corrosion inhibitor, dissolved silica, and water; (xiii) at least one etchant source, at least one organic solvent, at least one metal corrosion inhibitor, dissolved silica, and water; (xiv) fluorosilicic acid, at least one organic solvent, at least one metal corrosion inhibitor, dissolved silica, and water; (xv) at least one etchant, at least one organic solvent, at least one low-k passivating agent, at least one corrosion inhibitor and water; or (xvi) at least one etchant, at least one organic solvent, and water.

The water is included to serve as a solvent and assist in the dissolution of residues, e.g., water-soluble copper oxide residues. The water is preferably deionized.

In a preferred embodiment of the invention, the aqueous cleaning composition of the first aspect is substantially devoid of oxidizing agents such as peroxide-containing compounds and nitric acid. In another preferred embodiment, the aqueous cleaning composition of the first aspect is substantially devoid of abrasive material prior to contact with the substrate to be cleaned.

The pH range of the aqueous cleaning composition of the first aspect is about 0 to about 5, preferably about 0 to about 4.5, and most preferably about 0 to about 2.5.

The etchant sources assist in breaking up and solubilizing the post-etch residue species, aiding in polymer sidewall residue removal and slightly etching of the TiN hardmask. Etchant sources contemplated herein include, but are not limited to: hydrofluoric acid (HF); fluorosilicic acid (H₂SiF₆); fluoroboric acid; ammonium fluorosilicate salt ((NH₄)₂SiF₆); tetramethylammonium hexafluorophosphate; ammonium fluoride salts; ammonium bifluoride salts; tetrabutylammonium tetrafluoroborate (TBA-BF₄); propylene glycol/HF in a weight ratio of about 90:10 to about 99:1, preferably about 93:7 to about 98:2; propylene glycol/tetraalkylammonium fluoride, where the alkyl groups may be the same as or different from one another and are selected from the group consisting of straight chained or branched C₁-C₆ alkyl groups (e.g., methyl, ethyl, propyl, butyl, pentyl, hexyl), in a weight ratio of about 75:25 to about 95:5, preferably about 80:20 to about 90:10; propylene glycol/tetrabutylammonium fluoride in a weight ratio of about 75:25 to about 95:5, preferably about 80:20 to about 90:10; propylene glycol/benzyltrimethylammonium fluoride in a weight ratio of about 75:25 to about 95:5, preferably about 80:20 to about 90:10; and combinations thereof. Preferably, the etchant source comprises fluorosilicic acid, propylene glycol/HF mixture, TBA-BF₄, and combinations thereof. When compatibility with copper-containing layers is important, ammonium fluorosilicate may be used so that the pH of the aqueous cleaning composition is higher (e.g., in a range from about 2 to about 4, more preferably about 3) and hence more compatible with the copper-containing layers.

The organic solvents assist in the penetration/swelling and/or dissolution of organic residues, wet the surface of the microelectronic device structure to facilitate residue removal, prevent residue redeposition, and/or passivate the underlying materials, e.g., ULK. Organic solvents contemplated herein include, but are not limited to, alcohols, ethers, pyrrolidinones, glycols, amines, and glycol ethers, including, but not limited to, methanol, ethanol, isopropanol, butanol, and higher alcohols (such as C₂-C₄ diols and C₂-C₄ triols), halogenated alcohols (such as 3-chloro-1,2-propanediol, 3-chloro-1-propanethiol, 1-chloro-2-propanol, 2-chloro-1-propanol, 3-chloro-1-propanol, 3-bromo-1,2-propanediol, 1-bromo-2-propanol, 3-bromo-1-propanol, 3-iodo-1-propanol, 4-chloro-1-butanol, 2-chloroethanol), dichloromethane, chloroform, acetic acid, propionic acid, trifluoroacetic acid, tetrahydrofuran (THF), N-methylpyrrolidinone (NMP), cyclohexylpyrrolidinone, N-octylpyrrolidinone, N-phenylpyrrolidinone, methyldiethanolamine, methyl formate, dimethyl formamide (DMF), dimethylsulfoxide (DMSO), tetramethylene sulfone (sulfolane), diethyl ether, phenoxy-2-propanol (PPh), propriophenone, ethyl lactate, ethyl acetate, ethyl benzoate, acetonitrile, acetone, ethylene glycol, propylene glycol (PG), 1,3-propanediol, 1,4-propanediol, dioxane, butyryl lactone, butylene carbonate, ethylene carbonate, propylene carbonate, dipropylene glycol, diethylene glycol monomethyl ether, triethylene glycol monomethyl ether, diethylene glycol monoethyl ether, triethylene glycol monoethyl ether, ethylene glycol monopropyl ether, ethylene glycol monobutyl ether, diethylene glycol monobutyl ether (i.e., butyl carbitol), triethylene glycol monobutyl ether, ethylene glycol monohexyl ether, diethylene glycol monohexyl ether, ethylene glycol phenyl ether, propylene glycol methyl ether, dipropylene glycol methyl ether (DPGME), tripropylene glycol methyl ether (TPGME), dipropylene glycol dimethyl ether, dipropylene glycol ethyl ether, propylene glycol n-propyl ether, dipropylene glycol n-propyl ether (DPGPE), tripropylene glycol n-propyl ether, propylene glycol n-butyl ether, dipropylene glycol n-butyl ether, tripropylene glycol n-butyl ether, propylene glycol phenyl ether, and combinations thereof. In addition, the organic solvent may comprise other amphiphilic species, i.e., species that contain both hydrophilic and hydrophobic moieties similar to surfactants. Hydrophobic properties may generally be imparted by inclusion of a molecular group consisting of hydrocarbon or fluorocarbon groups and the hydrophilic properties may generally be imparted by inclusion of either ionic or uncharged polar functional groups. Preferably, the organic solvent includes tripropylene glycol methyl ether (TPGME), dipropylene glycol methyl ether (DPGME), propylene glycol, gamma-butyrolactone, and combinations thereof. When present, the composition includes at least 0.01 wt % organic solvent, based on the total weight of the composition.

The metal corrosion inhibitors serve to eliminate over-etching of metals, e.g., copper, tungsten, and/or cobalt interconnect metals. Suitable corrosion inhibitors include, but are not limited to, azoles such as benzotriazole (BTA), 1,2,4-triazole (TAZ),5-aminotetrazole (ATA), 1-hydroxybenzotriazole, 5-amino-1,3,4-thiadiazol-2-thiol, 3-amino-1H-1,2,4 triazole, 3,5-diamino-1,2,4-triazole, tolyltriazole, 5-phenyl-benzotriazole, 5-nitro-benzotriazole, 3-amino-5-mercapto-1,2,4-triazole, 1-amino-1,2,4-triazole, 2-(5-amino-pentyl)-benzotriazole, 1-amino-1,2,3-triazole, 1-amino-5-methyl-1,2,3-triazole, 3-mercapto-1,2,4-triazole, 3-isopropyl-1,2,4-triazole, 5-phenylthiol-benzotriazole, halo-benzotriazoles (halo=F, Cl, Br or I), naphthotriazole, 1H-tetrazole-5-acetic acid, 2-mercaptobenzothiazole (2-MBT), 1-phenyl-2-tetrazoline-5-thione, 2-mercaptobenzimidazole (2-MBI), 4-methyl-2-phenylimidazole, 2-mercaptothiazoline, 2,4-diamino-6-methyl-1,3,5-triazine, thiazole, imidazole, benzimidazole, triazine, methyltetrazole, Bismuthiol I, 1,3-dimethyl-2-imidazolidinone, 1,5-pentamethylenetetrazole, 1-phenyl-5-mercaptotetrazole, diaminomethyltriazine, imidazoline thione, 4-methyl-4H-1,2,4-triazole-3-thiol, 5-amino-1,3,4-thiadiazole-2-thiol, benzothiazole, tritolyl phosphate, indazole, DNA bases (e.g., adenine, cytosine, guanine, thymine), phosphate inhibitors, amines, pyrazoles, iminodiacetic acid (IDA), propanethiol, silanes, secondary amines, benzohydroxamic acids, heterocyclic nitrogen inhibitors, citric acid, ascorbic acid, thiourea, 1,1,3,3-tetramethylurea, urea, urea derivatives, uric acid, potassium ethylxanthate, glycine, and mixtures thereof. Dicarboxylic acids such as oxalic acid, malonic acid, succinic acid, nitrilotriacetic acid, and combinations thereof are also useful copper passivator species. It is generally accepted that azoles chemisorb onto the copper surface and form an insoluble cuprous surface complex. Preferably, the corrosion inhibitor includes ascorbic acid, iminodiacetic acid (IDA), and benzotriazole (BTA). When present, the composition includes at least 0.01 wt % corrosion inhibitor, based on the total weight of the composition.

The inclusion of the chelating agent serves to chelate the oxidized copper and/or tungsten metals in the post-etch residue species and/or react with TiN and/or titanium-containing residues. Suitable chelating agents include, but are not limited to: fluorinated β-diketone chelating agents such as 1,1,1,5,5,5-hexafluoro-2,4-pentanedione (hfacH), 1,1,1-trifluoro-2,4-pentanedione (tfac), and acetylacetonate (acac); iminodiacetic acid; pyrazolates; amidinates; guanidinates; ketoimines; dienes; polyamines; ethylenediaminetetraacetic acid (EDTA); 1,2-cyclohexanediamine-N,N,N′,N′-tetraacetic acid (CDTA); etidronic acid; methanesulfonic acid; hydrochloric acid; acetic acid; acetylacetone; alkylamines; arylamines; glycolamines; alkanolamines; triazoles; thiazoles; tetrazoles; imidazoles; 1,4-benzoquinone; 8-hydroxyquinoline; salicylidene aniline; tetrachloro-1,4-benzoquinone; 2-(2-hydroxyphenyl)-benzoxazol; 2-(2-hydroxyphenyl)-benzothiazole; hydroxyquinoline sulfonic acid (HQSA); sulfosalicylic acid (SSA); salicylic acid (SA); tetramethylammonium halides, e.g., fluoride, chloride, bromide, iodide; and amines and amine-N-oxides including, but not limited to, pyridine, 2-ethylpyridine, 2-methoxypyridine and derivatives thereof such as 3-methoxypyridine, 2-picoline, pyridine derivatives, dimethylpyridine, piperidine, piperazine, triethylamine, triethanolamine, ethylamine, methylamine, isobutylamine, tert-butylamine, tributylamine, dipropylamine, dimethylamine, diglycol amine, monoethanolamine, methyldiethanolamine, pyrrole, isoxazole, 1,2,4-triazole, bipyridine, pyrimidine, pyrazine, pyridazine, quinoline, isoquinoline, indole, imidazole, N-methylmorpholine-N-oxide (NMMO), trimethylamine-N-oxide, triethylamine-N-oxide, pyridine-N-oxide, N-ethylmorpholine-N-oxide, N-methylpyrrolidine-N-oxide, N-ethylpyrrolidine-N-oxide, 1-methylimidazole, diisopropylamine, diisobutylamine, aniline, aniline derivatives, pentamethyldiethylenetriamine (PMDETA), and combinations of any of the above. Preferably, the chelating agent is methanesulfonic acid, hydrochloric acid, PMDETA, and combinations thereof. When present, the composition includes at least 0.01 wt % chelating agent, based on the total weight of the composition.

The compositions of the first aspect of the invention may optionally further include a surfactant to assist in residue removal, wet the surface, and/or prevent residue redeposition. Illustrative surfactants include, but are not limited to, amphoteric salts, cationic surfactants, anionic surfactants, fluoroalkyl surfactants, SURFONYL® 104, TRITON® CF-21, ZONYL® UR, ZONYL® FSO-100, ZONYL® FSN-100, 3M Fluorad fluorosurfactants (i.e., FC-4430 and FC-4432), dioctylsulfosuccinate salt, 2,3-dimercapto-1-propanesulfonic acid salt, dodecylbenzenesulfonic acid, polyethylene glycols, polypropylene glycols, polyethylene or polypropylene glycol ethers, carboxylic acid salts, R₁ benzene sulfonic acids or salts thereof (where the R₁ is a straight-chained or branched C₈-C₁₈ alkyl group), amphiphilic fluoropolymers, polyethylene glycols, polypropylene glycols, polyethylene or polypropylene glycol ethers, carboxylic acid salts, dodecylbenzenesulfonic acid, polyacrylate polymers, dinonylphenyl polyoxyethylene, silicone or modified silicone polymers, acetylenic diols or modified acetylenic diols, alkylammonium or modified alkylammonium salts, as well as combinations comprising at least one of the foregoing surfactants, sodium dodecyl sulfate, zwitterionic surfactants, aerosol-OT (AOT) and fluorinated analogues thereof, alkyl ammonium, perfluoropolyether surfactants, 2-sulfosuccinate salts, phosphate-based surfactants, sulfur-based surfactants, and acetoacetate-based polymers. When present, the composition includes at least 0.01 wt % surfactant, based on the total weight of the composition.

The compositions of the first aspect of the invention may further include a source of silica. It was surprisingly discovered that a high TiN:ULK selectivity could be obtained using an aqueous composition including an etchant plus dissolved silica. The silica may be added to the composition as a fine silica powder, or as a tetraalkoxysilane such as TEOS, preferably at a ratio of etchant to silica source of about 4:1 to about 5:1. In a particularly preferred embodiment, the etchant source is fluorosilicic acid and the silica source is TEOS. The preferred embodiment further includes a glycol based solvent to facilitate the dissolution of the silica source in the composition. When present, the composition includes at least 0.01 wt % silica, based on the total weight of the composition.

The low-k passivating agents may be included to reduce the chemical attack of the low-k layers and to protect the wafer from additional oxidation. Boric acid is a presently preferred low-k passivating agent, although other hydroxyl additives may also be advantageously employed for such purpose, e.g., 3-hydroxy-2-naphthoic acid, malonic acid, iminodiacetic acid, and mixtures thereof. Preferably, the low-k passivating agent comprises iminodiacetic acid. When present, the composition includes at least 0.01 wt % low-k passivating agent, based on the total weight of the composition. Preferably, less than 2 wt. % of the underlying low-k material is etched/removed using the removal compositions of the present invention, more preferably less than 1 wt. %, most preferably less than 0.5 wt. %, based on the total weight of the underlying low-k material.

In various preferred embodiments, the aqueous cleaning composition of the first aspect of the invention is formulated in the following Formulations A-S, wherein all percentages are by weight, based on the total weight of the formulation:

Formulation A: Fluorosilicic acid: 1.2 wt %; Butyl carbitol: 15.0 wt %; Water: 72.8 wt %; Ascorbic acid: 1.0 wt %; Methanesulfonic acid: 10.0 wt %
Formulation B: Fluorosilicic acid: 1.2 wt %; Butyl carbitol: 15.0 wt %; Water: 72.8 wt %; Ascorbic acid: 1.0 wt %; Acetic acid: 10.0 wt %
Formulation C: Fluorosilicic acid: 1.2 wt %; Water: 87.8 wt %; ZONYL FSO-100:0.5 wt %; Ascorbic acid: 0.5 wt %; Acetic acid: 10.0 wt %
Formulation D: Fluorosilicic acid: 0.7 wt %; Butyl carbitol: 8.0 wt %; Water: 86.1 wt %; Ascorbic acid: 0.2 wt %; Methanesulfonic acid: 5.0 wt %
Formulation E: Fluorosilicic acid: 0.9 wt %; Butyl carbitol: 32.4 wt %; Water: 59.9 wt %; Ascorbic acid: 0.3 wt %; Methanesulfonic acid: 6.5 wt %
Formulation F: Fluorosilicic acid: 0.6 wt %; Butyl carbitol: 19.7 wt %; Water: 67.7 wt %; Ascorbic acid: 0.2 wt %; Methanesulfonic acid: 11.8 wt %
Formulation G: Fluorosilicic acid: 0.7 wt %; Butyl carbitol: 8.0 wt %; Water: 85.9 wt %; Ascorbic acid: 0.2 wt %; Methanesulfonic acid: 5.0 wt %; Hydrochloric acid: 0.2 wt %
Formulation H: Fluorosilicic acid: 0.7 wt %; Butyl carbitol: 8.0 wt %; Water: 88.3 wt %; Ascorbic acid: 0.5 wt %; NMMO: 2.5 wt %
Formulation I: Water: 88.63 wt %; Di(propylene glycol) methyl ether: 6.75 wt %; H₂SiF₆: 1.01 wt %; TEOS: 0.29 wt %; Pentamethyldiethylenetriamine: 1.20 wt %; Ascorbic Acid: 2.41 wt %; pH=3; density=1.01 g/mL
Formulation J: Water: 91.64 wt %; Di(propylene glycol) methyl ether: 5.00 wt %; H₂SiF₆: 1.01 wt %; TEOS: 0.35 wt %; Sulfolane: 2.00 wt %; pH=1.60; density=1.01 g/mL
Formulation K: 3-chloro-1,2-propanediol: 40.00 wt %; water: 43.40 wt %; boric acid: 1.00 wt %; tripropylene glycol methyl ether: 25.00 wt %; ascorbic acid: 0.50 wt %; TBA-BR₄: 0.10 wt %
Formulation L: 3-chloro-1,2-propanediol: 40.00 wt %; water: 35.50 wt %; boric acid: 1.00 wt %; tripropylene glycol methyl ether: 20.00 wt %; ascorbic acid: 2.00 wt %; TBA-BR₄: 0.50 wt %; malonic acid: 1.00 wt %
Formulation M: Water: 88.97 wt %; Di(propylene glycol) methyl ether: 6.71 wt %; H₂SiF₆: 1.01 wt %; TEOS: 0.30 wt %; Ascorbic Acid: 2.39 wt %; Iminodiacetic Acid: 0.62 wt %
Formulation N: Water 89.45 wt %; Di(propylene glycol) methyl ether: 6.83 wt %; (NH₄)₂SiF₆: 0.99 wt %; TEOS: 0.29 wt %; Ascorbic Acid: 2.44 wt %; pH=2.9; density=1.01 g/mL
Formulation O: Water: 79.0 wt %; 3-chloro-1,2-propanediol: 20.0 wt %; Bz TMAF: 0.15 wt %; propylene glycol: 0.85 wt %; pH=2.7
Formulation P: Water: 78.7 wt %; 3-chloro-1,2-propanediol: 20.0 wt %; Bz TMAF: 0.15 wt %; propylene glycol: 0.85 wt %; BTA: 0.3 wt %; pH=3.5
Formulation Q: Water: 90.6 wt %; 3-chloro-1,2-propanediol: 8.0 wt %; Bz TMAF: 0.2 wt %; propylene glycol: 1.1 wt %; BTA: 0.1 wt %; pH=3.6
Formulation R: Water: 90.45 wt %; 3-chloro-1,2-propanediol: 8.0 wt %; Bz TMAF: 0.19 wt %; propylene glycol: 1.06 wt %; BTA: 0.3 wt %; pH 3.5
Formulation S: Water: 79.50-79.99 wt %; DMSO: 20.0 wt %; tetramethylammonium hexafluorophosphate 0.01-0.5 wt %

In another embodiment of the first aspect, the aqueous composition of the present invention includes fluorosilicic acid, at least one chelating agent, and water, wherein the weight percent ratios of the chelating agent(s) relative to the fluorosilicic acid is about 5 to about 20, and wherein the amount of water is less than 75 wt %, based on the total weight of the composition. In a particularly preferred embodiment, the chelating agent comprises methanesulfonic acid.

In another embodiment of this aspect, the aqueous composition of the first aspect of the present invention includes fluorosilicic acid, at least one metal corrosion inhibitor, and water, wherein the weight percent ratios of the metal corrosion inhibitor(s) relative to the fluorosilicic acid is about 0.30 to about 0.35 or about 0.80 to about 0.85, and wherein the amount of water is less than 75 wt %, based on the total weight of the composition. In a particularly preferred embodiment, the chelating agent comprises ascorbic acid.

In another embodiment of the first aspect, the aqueous composition of the present invention includes fluorosilicic acid, at least one organic solvent, at least one chelating agent, at least one metal corrosion inhibitor, and water, wherein the weight percent ratios of the organic solvent(s) relative to the fluorosilicic acid is about 10 to about 15, the weight percent ratios of the chelating agent(s) relative to the fluorosilicic acid is about 5 to about 12, the weight percent ratios of the metal corrosion inhibitor(s) relative to the fluorosilicic acid is about 0.80 to about 0.85, and wherein the amount of water is less than 75 wt %, based on the total weight of the composition. In a particularly preferred embodiment, the aqueous composition comprises fluorosilicic acid, diethylene glycol butyl ether, and ascorbic acid.

In another embodiment of the first aspect, the aqueous composition of the present invention includes fluorosilicic acid, at least one organic solvent, at least one chelating agent, at least one metal corrosion inhibitor, and water, wherein the weight percent ratios of the organic solvent(s) relative to the fluorosilicic acid is about 30 to about 38, the weight percent ratios of the chelating agent(s) relative to the fluorosilicic acid is about 5 to about 20, the weight percent ratios of the metal corrosion inhibitor(s) relative to the fluorosilicic acid is about 0.30 to about 0.35, and wherein the amount of water is less than 75 wt %, based on the total weight of the composition. In a particularly preferred embodiment, the aqueous composition comprises fluorosilicic acid, diethylene glycol butyl ether, ascorbic acid, and methanesulfonic acid.

In another embodiment of the first aspect, the aqueous composition includes at least one organic solvent, at least one etchant, at least one chelating agent, a source of silica, at least one tungsten corrosion inhibitor, and water. Suitable tungsten corrosion inhibitor include, but are not limited to, sulfolane, 2-mercaptothiazoline, 2,3,5-trimethylpyrazine, 2-ethyl-3,5-dimethylpyrazine, quinoxaline, acetyl pyrrole, pyridazine, histadine, pyrazine, glycine, benzimidazole, benzotriazole (BTA), iminodiacetic acid (IDA), glutathione (reduced), cysteine, 2-mercaptobenzimidazole, cystine, thiophene, mercapto pyridine N-oxide, thiamine HCl, tetraethyl thiuram disulfide, 1,2,4-triazole, 2,5-dimercapto-1,3-thiadiazoleascorbic acid, ascorbic acid, and combinations thereof, preferably sulfolane, pyrazine, glycine, histidine, ascorbic acid, and combinations thereof. In a particularly preferred embodiment, the aqueous composition includes at least one organic solvent, etchant, at least one chelating agent, a source of silica, at least one W-corrosion inhibitor and water wherein the weight percent ratios of the organic solvent(s) relative to the etchant is about 5 to about 8, preferably about 6.5 to about 7, the water relative to the etchant is about 85 to about 91, preferably about 86 to about 89, the source of silica relative to the etchant is about 0.1 to about 0.5, preferably about 0.25 to about 0.35, the chelating agent(s) relative to the etchant is about 0.5 to about 2.5, preferably about 1 to about 1.5, and the W-corrosion inhibitor(s) relative to the etchant is about 1 to about 4, preferably about 2 to about 2.5. The compositions of this embodiment may be used to etch TiN without substantially removing ULK, Cu or W or for Cu or W CMP. Preferably, the etchant comprises fluorosilicic acid. For example, in one embodiment, the aqueous composition comprises, consists of, or consists essentially of water, di(propylene glycol) methyl ether, pentamethyldiethylenetriamine, fluorosilicic acid, TEOS and ascorbic acid.

In another embodiment of the first aspect, the aqueous composition includes at least one organic solvent, at least one etchant, a source of silica, at least one tungsten corrosion inhibitor, and water. In a particularly preferred embodiment, the aqueous composition includes at least one organic solvent, etchant, a source of silica, at least one W-corrosion inhibitor and water, wherein the weight percent ratios of the organic solvent(s) relative to the etchant is about 3 to about 7, preferably about 4.5 to about 7, the water relative to the etchant is about 88 to about 93, preferably about 90 to about 91, the source of silica relative to the etchant is about 0.1 to about 0.5, preferably about 0.25 to about 0.35, and the W-corrosion inhibitor(s) relative to the etchant is about 1 to about 4, preferably about 2 to about 2.5. The compositions of this embodiment may be used to etch TiN without substantially removing ULK, Cu or W or for Cu or W CMP. Preferably, the etchant comprises fluorosilicic acid. For example, in one embodiment, the aqueous composition comprises, consists of, or consists essentially of water, di(propylene glycol) methyl ether, fluorosilicic acid, TEOS and sulfolane. In another embodiment, the aqueous composition comprises, consists of, or consists essentially of water, di(propylene glycol) methyl ether, ammonium fluorosilicate, TEOS and ascorbic acid.

In another embodiment of the first aspect, the aqueous composition includes at least one etchant, at least one organic solvent, at least one low-k passivating agent, at least one corrosion inhibitor and water. In a particularly preferred embodiment, the aqueous composition includes TBA-BF₄, at least one organic solvent, at least one low-k passivating agent, at least one corrosion inhibitor and water, wherein the weight percent ratios of the organic solvent(s) relative to the low-k passivating agent(s) is about 30 to about 70, preferably about 50 to about 65; the water relative to low-k passivating agent(s) is about 25 to about 60, preferably 35 to about 50; the corrosion inhibitor(s) relative to low-k passivating agent(s) is about 0.1 to about 5, preferably about 0.5 to about 3; and the etchant(s) relative to low-k passivating agent(s) is about 0.01 to about 2, preferably about 0.05 to about 1.

In still another embodiment of the first aspect of the invention, the aqueous composition includes water, at least one organic solvent, at least one corrosion inhibitor, and at least one etchant. In a particularly preferred embodiment, the aqueous composition includes water, at least one organic solvent, and propylene glycol/benzyltrimethylammonium fluoride etchant, wherein the weight percent ratios of the organic solvent(s) relative to the PG/benzyltrimethylammonium fluoride etchant is about 60 to about 90, preferably about 70 to about 80; the water relative to PG/benzyltrimethylammonium fluoride etchant is about 2 to about 30, preferably 15 to about 25; and the corrosion inhibitor(s) relative to PG/benzyltrimethylammonium fluoride etchant is about 0.01 to about 0.5, preferably about 0.1 to about 0.3. For example, in one embodiment, the aqueous composition comprises, consists of, or consists essentially of water, 3-chloro-1,2-propanediol, benzyltrimethylammonium fluoride:propylene glycol, and benzotriazole.

In another embodiment of the first aspect, the aqueous compositions described herein further include post-plasma etch residue, wherein the post-plasma etch residue comprises residue material selected from the group consisting of titanium-containing residue, polymeric-residue, copper-containing residue, tungsten-containing residue, cobalt-containing residue, and combinations thereof. The residue material may be dissolved and/or suspended in the aqueous compositions of the invention.

In still another embodiment of the first aspect, the aqueous compositions described herein further include titanium nitride residue material. The residue material may be dissolved and/or suspended in the aqueous compositions of the invention.

The compositions of the first aspect of the invention are useful for the selective removal of TiN, sidewall residue, and/or post-etch residue without substantially etching patterned or blanket tungsten layers, copper layers and/or ULK layers. In addition to an aqueous solution, it is also contemplated herein that the aqueous cleaning compositions may be formulated as foams, fogs, subcritical or supercritical fluids (i.e., wherein the solvent is CO₂, etc., instead of water).

In a second aspect, the cleaning compositions of the invention are semi-aqueous or non-aqueous and include at least one organic solvent, and at least one metal-chelating agent, optionally at least one surfactant, optionally at least one corrosion inhibitor, optionally at least one low-k passivating agent, optionally at least one etchant, and optionally water, for removing post-plasma etch residues from the surface of a microelectronic device having same thereon, wherein the post-plasma etch residue comprises a species selected from the group consisting of titanium-containing residues, polymeric residues, copper-containing residues, tungsten-containing residues, cobalt-containing residues, and combinations thereof. In another embodiment, the cleaning compositions include at least one organic solvent, at least one metal-chelating agent, and at least one corrosion inhibitor. In still another embodiment, the cleaning compositions include at least one organic solvent, at least one metal-chelating agent, at least one corrosion inhibitor, and water. In another embodiment, the cleaning compositions of the invention include at least one organic solvent, at least one metal-chelating agent, at least one corrosion inhibitor, at least one surfactant, and water. In yet another embodiment, the cleaning compositions of the invention include at least one organic solvent, at least one metal-chelating agent, at least one corrosion inhibitor, at least one low-k passivating agent, and water. In still another embodiment, the cleaning compositions of the invention include at least one organic solvent, at least one metal-chelating agent, at least one corrosion inhibitor, at least one surfactant, at least one low-k passivating agent, and water. In another embodiment, the cleaning compositions of the invention include at least one organic solvent, at least one metal-chelating agent, and at least one etchant. In another embodiment, the cleaning compositions of the invention include at least one organic solvent, at least one metal-chelating agent, at least one corrosion inhibitor, and at least one etchant. The cleaning composition of this aspect of the invention removes post-plasma etch residues while simultaneously not compromising the metallic layers, including cobalt and cobalt-containing alloys, e.g., CoWP, TiN, and ILD materials on the microelectronic device surface.

In one embodiment of the second aspect, the present invention relates to an aqueous composition for cleaning post-plasma etch residues selected from the group consisting of titanium-containing residues, polymeric residues, copper-containing residues, tungsten-containing residues, cobalt-containing residues, and combinations thereof, said composition including at least one organic solvent, at least one metal-chelating agent, at least one corrosion inhibitor, water, optionally at least one surfactant, and optionally at least one low-k passivating agent, present in the following ranges, based on the total weight of the composition.

| component | % by weight | preferably % by weight |
|---|---|---|
| organic solvent | about 5% to about 50% | about 20% to about 45% |
| chelating agent(s) | about 0.5% to about 30% | about 2% to about 20% |
| metal corrosion | about 0.01% to about 10% | about 0.1% to about 2% |
| inhibitor(s) | | |
| water | about 50% to about 97% | about 40% to about 75% |
| surfactant(s) | 0 to about 10% | 0.01 to about 2.5% |
| | | (when present) |
| low-k passivating | 0 to about 10% | 0.01 to about 2.5% |
| agent(s) | | (when present) |

In another embodiment of the second aspect, the present invention relates to a non-aqueous composition for cleaning post-plasma etch residues selected from the group consisting of titanium-containing residues, polymeric residues, copper-containing residues, tungsten-containing residues, cobalt-containing residues, and combinations thereof, said composition including at least one organic solvent and at least one metal-chelating agent, present in the following ranges, based on the total weight of the composition.

| | | preferably % | most preferably |
|---|---|---|---|
| component | % by weight | by weight | % by weight |
| organic solvent | about 2% to | about 70% to | about 80% to |
| | about 99% | about 95% | about 90% |
| chelating | about 0.1% to | about 5% to | about 10% to |
| agent(s) | about 30% | about 25% | about 20% |

In yet another embodiment of the second aspect, the present invention relates to a composition for cleaning post-plasma etch residues selected from the group consisting of titanium-containing residues, polymeric residues, copper-containing residues, tungsten-containing residues, cobalt-containing residues, and combinations thereof, said composition including at least one organic solvent at least one metal-chelating agent, and at least one etchant, present in the following ranges, based on the total weight of the composition.

| | | preferably % | most preferably |
|---|---|---|---|
| component | % by weight | by weight | % by weight |
| organic solvent | about 2% to | about 65% to | about 75% to |
| | about 99% | about 95% | about 90% |
| chelating agent(s) | about 0.1% to | about 5% to | about 10% to |
| | about 30% | about 25% | about 20% |
| etchant(s) or | about 0.01% to | about 0.1% to | about 0.5% to |
| PG/etchant | about 10% | about 5% | about 3% |
| mixture | | | |

Notably, the weight percent of the at least one etchant includes “neat” etchant or alternatively, the amount of the propylene glycol/etchant mixture, regardless of the weight ratio of propylene glycol to etchant. It is to be appreciated by one skilled in the art that the weight percent of etchant in the cleaning composition is less than the weight percent of the PG/etchant component added to the cleaning composition. For example, the weight percent of HF in the cleaning composition including 0.5 wt. % PG/HF (96:4) mixture is actually 0.02 wt. %.

In yet another embodiment of the second aspect, the present invention relates to a composition for cleaning post-plasma etch residues selected from the group consisting of titanium-containing residues, polymeric residues, copper-containing residues, tungsten-containing residues, cobalt-containing residues, and combinations thereof, said composition including at least one organic solvent at least one metal-chelating agent, at least one corrosion inhibitor, and at least one etchant, present in the following ranges, based on the total weight of the composition.

| | | preferably % | most preferably |
|---|---|---|---|
| component | % by weight | by weight | % by weight |
| organic solvent | about 2% to | about 65% to | about 70% to |
| | about 99% | about 95% | about 85% |
| chelating agent(s) | about 0.1% to | about 5% to | about 10% to |
| | about 30% | about 25% | about 20% |
| etchant(s) or | about 0.01% to | about 0.1% to | about 0.1% to |
| PG/etchant | about 10% | about 5% | about 2% |
| mixture | | | |
| corrosion | about 0.01% to | about 0.1% to | about 0.2 to |
| inhibitor | about 5% | about 3% | about 1.5% |

Notably, the weight percent of the at least one etchant includes “neat” etchant or alternatively, the amount of the propylene glycol/etchant mixture, regardless of the weight ratio of propylene glycol to etchant. It is to be appreciated by one skilled in the art that the weight percent of etchant in the cleaning composition is less than the weight percent of the PG/etchant component added to the cleaning composition. For example, the weight percent of HF in the cleaning composition including 0.5 wt. % PG/HF (96:4) mixture is actually 0.02 wt. %.

In the broad practice of the invention, the cleaning composition may comprise, consist of, or consist essentially of: (i) at least one organic solvent and at least one chelating agent; (ii) at least one organic solvent, at least one metal-chelating agent, and at least one corrosion inhibitor; (iii) at least one organic solvent, at least one metal-chelating agent, at least one corrosion inhibitor, and water; (iv) at least one organic solvent, at least one metal-chelating agent, at least one corrosion inhibitor, and water; (v) at least one organic solvent, at least one metal-chelating agent, at least one corrosion inhibitor, at least one surfactant, and water; (vi) at least one organic solvent, at least one metal-chelating agent, at least one corrosion inhibitor, at least one low-k passivating agent, and water; (vii) at least one organic solvent, at least one metal-chelating agent, at least one corrosion inhibitor, at least one surfactant, at least one low-k passivating agent, and water; (viii) at least one organic solvent, at least one metal-chelating agent, and at least one etchant; and (ix) at least one organic solvent, at least one metal-chelating agent, at least one corrosion inhibitor, and at least one etchant.

The range of weight percent ratios of the components of the removal composition is: about 0.1 to about 20 organic solvent(s) relative to chelating agent(s), preferably about 3.5 to about 15, even more preferably about 3.5 to about 5; about 0.1 to about 50 water (when present) relative to chelating agent(s), preferably about 1 to about 25, and most preferably about 2 to about 12; about 0.001 to about 0.2 metal corrosion inhibitor (when present) relative to chelating agent(s), preferably about 0.01 to about 0.1; about 0.001 to about 0.2 low-k passivating agent(s) (when present) relative to chelating agent(s), preferably about 0.01 to about 0.1; and about 0.01 to about 1 etchant or PG/etchant mixture (when present) relative to chelating agent(s), preferably about 0.025 to about 0.35, even more preferably about 0.025 to about 0.15.

The organic solvent(s), chelating agent(s), corrosion inhibitor(s), etchant(s), and surfactant(s) for this aspect of the invention were previously described hereinabove. Preferably, the solvents include tripropylene glycol methyl ether, propylene glycol, gamma-butylrolactone and/or 3-chloro-1,2-propanediol. Preferably, the chelating agents include methanesulfonic acid, diisopropylamine, pentamethyldiethylenetriamine, and combinations thereof. The preferred etchants include PG/HF (96:4), PG/tetrabutylammonium fluoride (85/15), TBA-BF₄, or combinations thereof.

The water is preferably deionized.

In various preferred embodiments, the aqueous cleaning composition of this aspect of the invention is formulated in the following Formulations AA-AY, wherein all percentages are by weight, based on the total weight of the formulation:

Formulation AA: 30.0 wt. % diethylene glycol butyl ether; 62.87 wt. % water; 5.63 wt. % HCl; 1.00 wt. % triethanolamine; 0.50 wt. % ascorbic acid
Formulation AB: 30.0 wt. % diethylene glycol butyl ether; 54.00 wt. % water; 10.00 wt. % methanesulfonic acid; 5.00 wt. % acetylacetone; 0.50 wt. % iminodiacetic acid; 0.50 wt. % ascorbic acid
Formulation AC: 30.0 wt. % diethylene glycol butyl ether; 15.0 wt. % diethylene glycol methyl ether; 44.00 wt. % water; 10.00 wt. % methanesulfonic acid; 0.50 wt. % iminodiacetic acid; 0.50 wt. % ascorbic acid
Formulation AD: 30.0 wt. % diethylene glycol butyl ether; 15.0 wt. % tripropylene glycol methyl ether; 44.00 wt. % water; 10.00 wt. % methanesulfonic acid; 0.50 wt. % iminodiacetic acid; 0.50 wt. % ascorbic acid
Formulation AE: 90.0 wt. % 3-chloro-1,2-propanediol; 10.0 wt. % methanesulfonic acid
Formulation AF: 90.0 wt. % 3-chloro-1,2-propanediol; 9.0 wt. % methanesulfonic acid; 1.0 wt. % tetramethylammonium chloride
Formulation AG: 80.0 wt. % 3-chloro-1,2-propanediol; 20.0 wt. % diisopropylamine
Formulation AH: 80.0 wt. % tripropylene glycol methyl ether; 20.0 wt. % diisopropylamine
Formulation AI: 80.0 wt. % tripropylene glycol methyl ether; 20.0 wt. % pentamethyldiethylenetriamine
Formulation AJ: 40.0 wt. % 3-chloro-1,2-propanediol; 40.0 wt. % tripropylene glycol methyl ether; 20.0 wt. % pentamethyldiethylenetriamine
Formulation AK: 30.0 wt. % 3-chloro-1,2-propanediol; 30.0 wt. % tripropylene glycol methyl ether; 30.0 wt. % propylene carbonate; 10.0 wt. % methanesulfonic acid
Formulation AL: Methanesulfonic acid: 10.00 wt %; Tri(propylene glycol) methyl ether: 50.00 wt %; 3-Chloro-1,2-propanediol: 40.00 wt %; pH=1.70 (50:1 dilution with water); density=1.14 g mL⁻¹; viscosity=31.35 cSt at 25° C.
Formulation AM: Pentamethyldiethylenetriamine: 10.00 wt %; Tri(propylene glycol) methyl ether: 50.00 wt %; Propylene glycol: 40.00 wt %; pH=10.56 (50:1 dilution with water); density=0.98 g mL⁻¹; viscosity=14.55 cSt@25° C.
Formulation AN: Pentamethyldiethylenetriamine: 10.00 wt %; Tri(propylene glycol) methyl ether: 50.00 wt %; Propylene glycol: 39.25 wt %; PG/HF (96:4): 0.75 wt %; pH=10.40 (50:1 dilution with water); density=0.98 g/mL
Formulation AO: Pentamethyldiethylenetriamine: 10.00 wt %; Tri(propylene glycol) methyl ether: 50.00 wt %; Propylene glycol: 39.50 wt %; PG/HF (96:4): 0.50 wt %; pH=10.40 (50:1 dilution with water); density=0.98 g/mL
Formulation AP: Pentamethyldiethylenetriamine: 20.00 wt %; tri(propylene glycol) methyl ether: 44.444 wt %; Propylene glycol: 35.556 wt %; pH=10.56 (50:1 dilution with water); density=0.98 g/mL
Formulation AQ: Pentamethyldiethylenetriamine: 9.756 wt %; Tri(propylene glycol) methyl ether: 48.780 wt %; Propylene glycol: 39.024 wt %; PG/Tetrabutyl ammonium fluoride (85:15): 2.440 wt %
Formulation AR: Pentamethyldiethylenetriamine: 9.756 wt %; Tri(propylene glycol) methyl ether: 48.780 wt %; Propylene glycol: 39.024 wt %; PG/Benzyl methyl ammonium fluoride (85:15): 2.440 wt %
Formulation AS: Pentamethyldiethylenetriamine: 20.00 wt %; Tri(propylene glycol) methyl ether: 44.20 wt %; Propylene glycol: 35.30 wt %; Tetrabutylammonium tetrafluoroborate (TBA-BF₄): 0.50 wt %
Formulation AT: Pentamethyldiethylenetriamine: 20.00 wt %; Tri(propylene glycol) methyl ether: 39.75 wt %; Propylene glycol: 39.75 wt %; Tetrabutylammonium tetrafluoroborate (TBA-BF₄): 0.50 wt %
Formulation AU: Pentamethyldiethylenetriamine: 20.00 wt %; Tri(propylene glycol) methyl ether: 22.30 wt %; Propylene glycol: 57.20 wt %; Tetrabutylammonium tetrafluoroborate (TBA-BF₄): 0.50 wt %
Formulation AV: Pentamethyldiethylenetriamine: 20.00 wt %; Tri(propylene glycol) methyl ether: 20.00 wt %; Propylene glycol: 42.00 wt %; gamma-Butyrolactone (GBL): 15.00 wt %; PG/HF (96:4): 3.00 wt %
Formulation AW: Pentamethyldiethylenetriamine: 20.00 wt %; Propylene glycol: 52.00 wt %; gamma-Butyrolactone: 25.00 wt %; PG/HF (96:4): 3.00 wt %; pH=9.90 (50:1 dilution with water); density=1.03 g/mL
Formulation AX: Pentamethyldiethylenetriamine: 20.00 wt %; Propylene glycol: 52.00 wt %;

Tri(propylene glycol) methyl ether: 25.00 wt %; PG/HF (96:4): 3.00 wt %

Formulation AY: Pentamethyldiethylenetriamine: 19.98 wt %; Propylene glycol: 51.31 wt %; gamma-Butyrolactone: 24.97 wt %; PG/HF (96:4): 2.99 wt %; Benzotriazole: 0.75 wt %; pH=10.03 (50:1 dilution with water); density=1.03 g/mL

In another embodiment of the second aspect, the cleaning compositions described herein further include post-plasma etch residue, wherein the post-plasma etch residue comprises residue material selected from the group consisting of titanium-containing residue, polymeric-residue, copper-containing residue, tungsten-containing residue, cobalt-containing residues, and combinations thereof. Importantly, the residue material may be dissolved and/or suspended in the aqueous compositions of the invention.

In a particularly preferred embodiment of the second aspect, the cleaning composition includes at least one glycol ether, water, methanesulfonic acid, iminodiacetic acid, and ascorbic acid, wherein the at least one glycol ether includes diethylene glycol butyl ether and/or tripropylene glycol methyl ether. In another preferred embodiment of the second aspect, the cleaning composition includes pentamethyldiethylenetriamine, propylene glycol, gamma-butryolactone and PG/HF. In yet another preferred embodiment, the cleaning composition includes pentamethyldiethylenetriamine, propylene glycol, gamma-butryolactone, PG/HF, and benzotriazole.

The compositions of the first aspect of the invention are useful for the selective removal of sidewall residue, and/or post-etch residue without substantially etching patterned or blanket tungsten layers, TiN, copper layers and/or ULK layers. In addition to a liquid solution, it is also contemplated herein that the compositions of both aspects of the invention may be formulated as foams, fogs, subcritical or supercritical fluids (i.e., wherein the solvent is CO₂, etc., instead of water).

Advantageously, the cleaning compositions of both aspects of the invention effectively remove post-plasma etch residue from the top surface, the sidewalls, and the vias and lines of the microelectronic device without compromising the ILD, capping layers, and/or the metal interconnect layers present on the device. In addition, the compositions may be used regardless of whether the trench or the via is etched first.

It will be appreciated that in general cleaning applications, it is common practice to make highly concentrated forms to be used at extreme dilutions. For example, the cleaning compositions may be manufactured in a more concentrated form, including at least about 20 wt % for solubility purposes, and thereafter diluted with additional solvent (e.g., water and/or organic solvent) at the manufacturer, before use, and/or during use at the fab. Dilution ratios may be in a range from about 0.1 part diluent:1 part removal composition concentrate to about 3 parts diluent:1 part removal composition concentrate, preferably about 1:1. It is understood that upon dilution, the weight percent ratios of many of the components of the removal composition will remain unchanged.

The compositions of both aspects of the invention are easily formulated by simple addition of the respective ingredients and mixing to homogeneous condition. Furthermore, the compositions may be readily formulated as single-package formulations or multi-part formulations that are mixed at the point of use, preferably multi-part formulations. The individual parts of the multi-part formulation may be mixed at the tool or in a storage tank upstream of the tool. The concentrations of the respective ingredients may be widely varied in specific multiples of the composition, i.e., more dilute or more concentrated, in the broad practice of the invention, and it will be appreciated that the compositions of the invention can variously and alternatively comprise, consist or consist essentially of any combination of ingredients consistent with the disclosure herein.

Accordingly, another aspect of the invention relates to a kit including, in one or more containers, one or more components adapted to form the compositions of the invention. Preferably, the kit includes, in one or more containers, the preferred combination of at least one etchant source, at least one metal-chelating agent, optionally water, optionally at least one organic solvent, optionally at least one corrosion inhibitor, optionally at least one low-k passivating agent, optionally at least one surfactant, and optionally a source of silica, for combining with or without additional water and/or organic solvent at the fab or the point of use. Alternatively, the kit includes, in one or more containers, the preferred combination of at least one etchant source, at least one metal corrosion inhibitor, optionally water, optionally at least one organic solvent, optionally at least one chelating agent, optionally at least one low-k passivating agent, optionally at least one surfactant, and optionally a source of silica, for combining with or without additional water and/or organic solvent at the fab or the point of use. Alternatively, the kit includes, in one or more containers, the preferred combination of at least one etchant source, at least one organic solvent, optionally water, optionally at least one metal corrosion inhibitor, optionally at least one chelating agent, optionally at least one low-k passivating agent, optionally at least one surfactant, and optionally a source of silica, for combining with or without additional water and/or organic solvent at the fab or the point of use. Alternatively, the kit includes, in one or more containers, the preferred combination at least one organic solvent, and at least one metal-chelating agent, optionally at least one surfactant, optionally at least one corrosion inhibitor, optionally at least one low-k passivating agent, optionally at least one etchant, and optionally water, for combining with or without additional water and/or organic solvent at the fab or the point of use. The containers of the kit must be suitable for storing and shipping said cleaning composition components, for example, NOWPak® containers (Advanced Technology Materials, Inc., Danbury, Conn., USA). The one or more containers which contain the components of the removal composition preferably include means for bringing the components in said one or more containers in fluid communication for blending and dispense. For example, referring to the NOWPak® containers, gas pressure may be applied to the outside of a liner in said one or more containers to cause at least a portion of the contents of the liner to be discharged and hence enable fluid communication for blending and dispense. Alternatively, gas pressure may be applied to the head space of a conventional pressurizable container or a pump may be used to enable fluid communication. In addition, the system preferably includes a dispensing port for dispensing the blended removal composition to a process tool.

Substantially chemically inert, impurity-free, flexible and resilient polymeric film materials, such as high density polyethylene, are preferably used to fabricate the liners for said one or more containers. Desirable liner materials are processed without requiring co-extrusion or barrier layers, and without any pigments, UV inhibitors, or processing agents that may adversely affect the purity requirements for components to be disposed in the liner. A listing of desirable liner materials include films comprising virgin (additive-free) polyethylene, virgin polytetrafluoroethylene (PTFE), polypropylene, polyurethane, polyvinylidene chloride, polyvinylchloride, polyacetal, polystyrene, polyacrylonitrile, polybutylene, and so on. Preferred thicknesses of such liner materials are in a range from about 5 mils (0.005 inch) to about 30 mils (0.030 inch), as for example a thickness of 20 mils (0.020 inch).

Regarding the containers for the kits of the invention, the disclosures of the following patents and patent applications are hereby incorporated herein by reference in their respective entireties: U.S. Pat. No. 7,188,644 entitled “APPARATUS AND METHOD FOR MINIMIZING THE GENERATION OF PARTICLES IN ULTRAPURE LIQUIDS;” U.S. Pat. No. 6,698,619 entitled “RETURNABLE AND REUSABLE, BAG-IN-DRUM FLUID STORAGE AND DISPENSING CONTAINER SYSTEM;” and U.S. patent application No. 60/916,966 entitled “SYSTEMS AND METHODS FOR MATERIAL BLENDING AND DISTRIBUTION” filed on May 9, 2007 in the name of John E.Q. Hughes.

As applied to microelectronic manufacturing operations, the cleaning compositions of both aspects of the invention are usefully employed to clean post-plasma etch residue from the surface of the microelectronic device, and may be applied to said surface before or after the application of other compositions formulated to remove alternative materials from the surface of the device. Importantly, the compositions of the invention do not damage ILD materials on the device surface and preferably remove at least 90% of the residue present on the device prior to removal processing, more preferably at least 95%, and most preferred at least 99% of the residue to be removed is removed.

In post-plasma etch residue removal application, the composition may be applied in any suitable manner to the device to be cleaned, e.g., by spraying the composition on the surface of the device to be cleaned, by dipping the device to be cleaned in a static or dynamic volume of the composition, by contacting the device to be cleaned with another material, e.g., a pad, or fibrous sorbent applicator element, that has the composition absorbed thereon, or by any other suitable means, manner or technique by which the composition is brought into removal contact with the device to be cleaned. Further, batch or single wafer processing is contemplated herein.

In use of the compositions of both aspects of the invention for removing post-plasma etch residue from microelectronic devices having same thereon, the composition typically is statically or dynamically contacted with the device for a time of from about 1 minute to about 30 minutes, preferably about 1 minute to 10 minutes, at temperature in a range of from about 20° C. to about 90° C., preferably about 40° C. to about 70° C., and most preferably about 50° C. to about 60° C. Preferably, the contacting is static. Such contacting times and temperatures are illustrative, and any other suitable time and temperature conditions may be employed that are efficacious to at least partially remove the post-etch residue material from the device, within the broad practice of the invention. “At least partial removal” of the residue material from the microelectronic device corresponds to at removal of at least 90% of the material, preferably at least 95% removal. Most preferably, at least 99% of said residue material is removed using the compositions of the present invention.

Following the achievement of the desired removal action, the compositions of both aspects of the invention may be readily removed from the device to which it has previously been applied, e.g., by rinse, wash, or other removal step(s), as may be desired and efficacious in a given end use application of the compositions of the present invention. For example, the device may be rinsed with a rinse solution including deionized water and/or dried (e.g., spin-dry, N₂, vapor-dry etc.).

When necessary, a post-clean bake step and/or an isopropanol vapor-dry step may be necessary to remove non-volatile materials that may absorb into the pores of the ILD materials so as not to change the capacitance of the low-k dielectric materials.

Another aspect of the invention relates to the improved microelectronic devices made according to the methods of the invention and to products containing such microelectronic devices.

A still further aspect of the invention relates to methods of manufacturing an article comprising a microelectronic device, said method comprising contacting the microelectronic device with a composition for sufficient time to clean post-plasma etch residue from the microelectronic device having said residue thereon, and incorporating said microelectronic device into said article, wherein the composition includes at least one etchant source, at least one metal-chelating agent, water, optionally at least one organic solvent, optionally at least one corrosion inhibitor, optionally at least one low-k passivating agent, optionally at least one surfactant, and optionally a source of silica.

A still further aspect of the invention relates to methods of manufacturing an article comprising a microelectronic device, said method comprising contacting the microelectronic device with a composition for sufficient time to clean post-plasma etch residue from the microelectronic device having said residue thereon, and incorporating said microelectronic device into said article, wherein the composition includes at least one etchant source, at least one metal corrosion inhibitor, water, optionally at least one organic solvent, optionally at least one chelating agent, optionally at least one low-k passivating agent, optionally at least one surfactant, and optionally a source of silica.

A still further aspect of the invention relates to methods of manufacturing an article comprising a microelectronic device, said method comprising contacting the microelectronic device with a composition for sufficient time to clean post-plasma etch residue from the microelectronic device having said residue thereon, and incorporating said microelectronic device into said article, wherein the composition includes at least one etchant source, at least one organic solvent, water, optionally at least one metal corrosion inhibitor, optionally at least one chelating agent, optionally at least one low-k passivating agent, optionally at least one surfactant, and optionally a source of silica.

A still further aspect of the invention relates to methods of manufacturing an article comprising a microelectronic device, said method comprising contacting the microelectronic device with a composition for sufficient time to clean post-plasma etch residue from the microelectronic device having said residue thereon, and incorporating said microelectronic device into said article, wherein the composition includes at least one organic solvent, and at least one metal-chelating agent, optionally at least one surfactant, optionally at least one corrosion inhibitor, optionally at least one low-k passivating agent, optionally at least one etchant, and optionally water.

In yet another aspect, the compositions of both aspects of the invention may be utilized in other aspects of the microelectronic device manufacturing process, i.e., subsequent to the post-plasma etch residue cleaning step. For example, the compositions may be diluted and used as a post-chemical mechanical polishing (CMP) clean. Alternatively, the compositions of the present invention may be used to remove contaminating materials from photomask materials for re-use thereof. In yet another alternative, the compositions of the first aspect of the invention may be used to etch TiN hardmasks, as readily determined by one skilled in the art.

One disadvantage associated with BEOL architecture including TiN hardmasks is the formation of TiOF crystals. Accordingly, in yet another aspect, the invention relates to a method comprising the removal of TiOF crystals from a microelectronic device having same thereon, said method comprising contacting the microelectronic device with an aqueous cleaning composition for sufficient time to at least partially remove said TiOF crystals from the microelectronic device, wherein the aqueous cleaning composition comprises at least one organic solvent, at least one etchant, a source of silica, at least one tungsten corrosion inhibitor, and water. Preferably, the contacting conditions include temperature in a range from about 35° C. to about 75° C., preferably about 50° C. to about 60° C., and the time is in a range from about 10 min to about 50 min, preferably about 20 min to about 35 min. Importantly, it is essential that the aqueous cleaning composition not substantially damage the ULK, Cu and/or W materials that may be present. In a particularly preferred embodiment, the aqueous composition includes at least one organic solvent, etchant, a source of silica, at least one W-corrosion inhibitor and water, wherein the weight percent ratios of the organic solvent(s) relative to the etchant is about 3 to about 7, the water relative to the etchant is about 88 to about 93, the source of silica relative to the etchant is about 0.1 to about 0.5, and the W-corrosion inhibitor(s) relative to the etchant is about 1 to about 4.

In yet another aspect, the invention relates to an article of manufacture comprising a microelectronic device substrate, residue material, and a cleaning composition, wherein the cleaning composition may be any composition described herein, and wherein the residue material is selected from the group consisting of titanium-containing residue, polymeric-residue, copper-containing residue, tungsten-containing residue, cobalt-containing residues, and combinations thereof.

The features and advantages of the invention are more fully illustrated by the following non-limiting examples, wherein all parts and percentages are by weight, unless otherwise expressly stated.

### Example 1

The etch rates of blanketed ULK, titanium nitride, Cu and W in Formulations A-H was determined. The thicknesses of the blanketed materials were measured before and after immersion in Formulations A-H at 50° C. Thicknesses were determined using a 4-point probe measurement whereby the resistivity of the composition is correlated to the thickness of the film remaining and the etch rate calculated therefrom. The experimental etch rates are reported in Table 1.

TABLE 1
Etch rate of ULK, TiN, Cu and W in Å min⁻¹
after immersion in Formulations A-H.

Etch rate/Å min⁻¹

| Formulation | ULK | TiN | Cu | W |
|---|---|---|---|---|
| A | 0 | 0 | 0 | 0 |
| B | 0 | 0 | 0 | 0 |
| C | 0 | 0 | 0 | 0 |
| D | 0 | 0 | 0 | 0 |
| E | 0 | 0 | 0 | 0 |
| F | 0 | 0 | 0 | 0 |
| G | 0 | 0 | 0 | 0 |
| H | 0 | 0 | 0 | 2.2 |

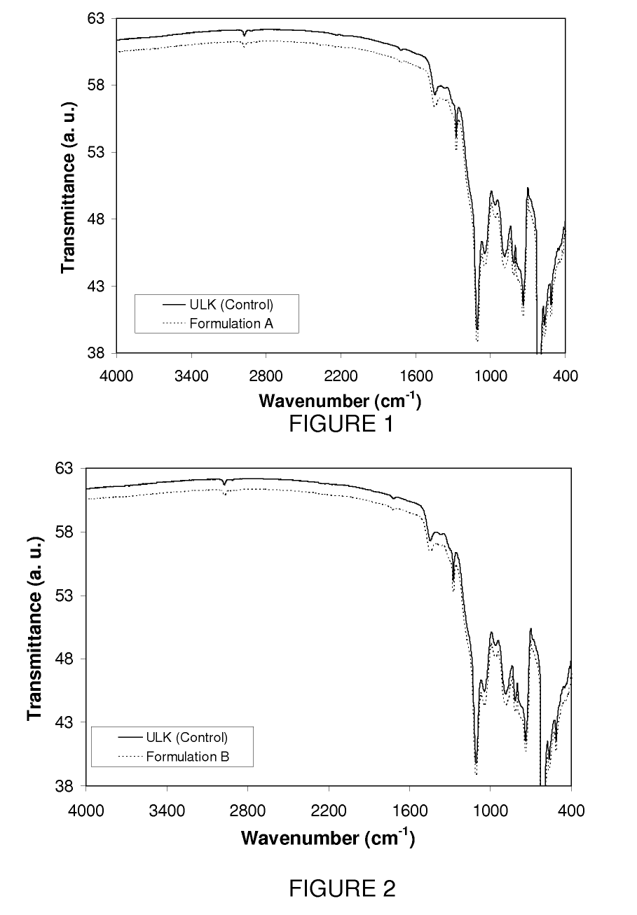

ULK compatability studies were also performed using Fourier Transform Infrared Spectroscopy (FTIR) and capacitance data. It can be seen in FIGS. 1 and 2 that no observable changes were observed in the ULK contacted with formulations A and B, respectively, relative to the ULK control, especially in the 2800 to 3000 cm⁻¹ hydrocarbon absorption region, which suggests that organic impurities did not absorb to the ULK. The capacitance data, as determined using an Hg probe, also suggests that the ULK was not detrimentally impacted by the formulations of the invention (see Table 2).

TABLE 2
Capacitance of ULK control relative to ULK
immersed in Formulations A, B, and H

| Sample | Capacitance (pF) |
|---|---|
| control | 35.5 ± 0.4 |
| formulation A | 35.7 ± 0.3 |
| formulation B | 35.7 ± 0.3 |
| formulation H | 35.6 ± 0.3 |

### Example 2

The etch rates of blanketed ULK, titanium nitride, Cu and W in Formulations AA and AB was determined. The thicknesses of the blanketed materials were measured before and after immersion in Formulations AA and AB at 50° C. Thicknesses were determined using a 4-point probe measurement whereby the resistivity of the composition is correlated to the thickness of the film remaining and the etch rate calculated therefrom. The experimental etch rates are reported in Table 3.

TABLE 3
Etch rate of ULK, TiN, Cu and W in Å min⁻¹ after
immersion in Formulations AA and AB.

Etch rate/Å min⁻¹

| Formulation | ULK | TiN | Cu | W |
|---|---|---|---|---|
| AA | 0 | 0 | 0 | 0 |
| AB | 0 | 0 | 0 | 0 |

ULK compatability studies were also performed using FTIR and capacitance data. No observable changes were observed in the ULK contacted with formulation AB, relative to the ULK control, especially in the 2800 to 3000 cm⁻¹ hydrocarbon absorption region, which suggests that organic impurities did not absorb to the ULK. The capacitance data, as determined using an Hg probe, also suggests that the ULK was not detrimentally impacted by the formulations of the invention (see Table 4).

TABLE 4
Capacitance of ULK control relative
to ULK immersed in Formulation AB

| Sample | Capacitance (pF) |
|---|---|
| post-etch ULK control | 44.0 ± 0.6 |
| formulation AB (50° C. for 5 | 44.2 ± 0.6 |
| minutes) + post-bake | |

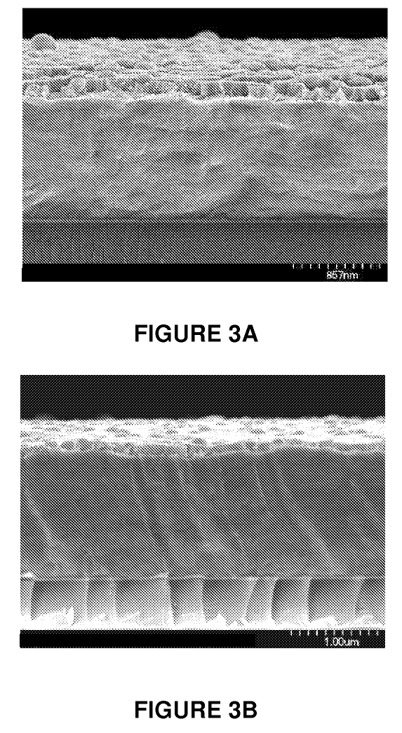

Cobalt compatibility was also determined. Blanketed CoWP wafers having a thickness of 1300 Å were immersed in Formulation AB for 2 hr at 50° C. Based on gravimetric analysis, the weight of the coupon before and after immersion was unchanged, suggesting that formulation AB did not etch CoWP. This is further evidenced in FIGS. 3A and 3B, which are micrographs of the blanketed CoWP wafer before (FIG. 3A) and after (FIG. 3B) processing in formulation AB.

### Example 3

The etch rates of blanketed ULK, titanium nitride, Cu and W in Formulations AC-AK was determined. The thicknesses of the blanketed materials were measured before and after immersion in Formulations AC-AK at 50° C. for 65 min. Thicknesses were determined using a 4-point probe measurement whereby the resistivity of the composition is correlated to the thickness of the film remaining and the etch rate calculated therefrom. The experimental etch rates are reported in Table 5.

TABLE 5
Etch rate of ULK, TiN, Cu and W in Å min⁻¹
after immersion in Formulations AC-AK.

Etch rate/Å min⁻¹

| Formulation | ULK | TiN | Cu | W |
|---|---|---|---|---|
| AC | 0 | 0 | 1.5 | 0 |
| AD | 0 | 0 | 0.2 | 0 |
| AE | 0 | 0 | 0 | 0 |
| AF | 0 | 0 | 0 | 0 |
| AG | 0 | 0 | 1.2 | 0 |
| AH | 0 | 0 | 0 | 0 |
| AI | — | — | 6.3 | 0 |
| AJ | — | — | 2.6 | 0 |
| AK | — | — | 2.4 | 0 |

ULK compatability studies were also performed at 50° C. for 65 min using FTIR and capacitance data. The capacitance data, as determined using an Hg probe, is reported in Table 6. The post-bake step, when applicable, was performed at 200-210° C. for 10 minutes.

TABLE 6
Capacitance of ULK control relative
to ULK immersed in Formulations AD-AF

| Sample | Capacitance (pF) |
|---|---|
| post-etch ULK control | 43.4 ± 1.5 |
| formulation AD | 48.0 ± 0.9 |
| formulation AD + post-bake | 42.5 ± 0.7 |
| formulation AE | 48.0 ± 1.7 |
| formulation AE + post-bake | 42.3 ± 0.5 |
| formulation AF | 45.0 ± 1.8 |
| formulation AF + post-bake | 41.7 ± 0.4 |
| formulation AF + IPA dry | 41.7 ± 0.6 |

It can be seen that the formulations do not cause a significant capacitance increase for the post-etch ULK when a post-bake or an IPA dry is employed. Further, no observable changes were observed in the post-etch ULK contacted with formulations AE or AF (both no post-bake and IPA dry), relative to the post-etch ULK control, especially in the 2800 to 3000 cm⁻¹ hydrocarbon absorption region, which suggests that organic impurities did not absorb to the ULK.

### Example 4

The etch rates of blanketed ULK, titanium nitride, Cu and W in Formulations AL-AY was determined. The thicknesses of the blanketed materials were measured before and after immersion in Formulations AL-AY at 50° C. for 65 min, unless noted otherwise. Thicknesses were determined using a 4-point probe measurement whereby the resistivity of the composition is correlated to the thickness of the film remaining and the etch rate calculated therefrom. The experimental etch rates are reported in Table 7.

TABLE 7
Etch rate of ULK, TiN, Cu and W in Å min⁻¹
after immersion in Formulations AL-AY.

Etch rate/Å min⁻¹

| Formulation | ULK | TiN | Cu | W |
|---|---|---|---|---|
| AL | 0 | 0 | 0.7 | 0 |
| AM | 0 | 0 | 0 | 0 |
| AN | 0 | 0 | 0.8 | 0 |
| AO | 0 | 0 | 0.5 | 0 |
| AP | 0 | 0 | 0 | 0 |
| AQ | 0 | 0 | 0 | 0 |
| AR | 0 | 0 | 0 | 0 |
| AS | 0 | 0 | 0 | 0 |
| AT | 0 | 0 | 0 | 0 |
| AU | 0 | 0 | 0 | 0 |
| AV | 0 | 0 (35 min) | 4.8 | 0 |
| AW | 0 | — (35 min) | — | 0 |
| AX | 0 | — (35 min) | — | 0 |
| AY | 0 | 0 (35 min) | 0.2 | 0 |

ULK compatability studies were also performed at 50° C. for 65 min using FTIR and capacitance data for formulations AM, AN, AO and/or AU. The capacitance data, as determined using an Hg probe, is reported in Table 8.

TABLE 8
Capacitance of ULK control relative to
ULK immersed in Formulations AN and AO.

| Sample | Capacitance (pF) |
|---|---|
| post-etch ULK control | 30.8 ± 2.1 |
| formulation AN | 29.3 ± 0.4 |
| formulation AO | 30.3 ± 0.5 |

It can be seen that the formulations do not cause a significant capacitance increase for the post-etch ULK when a post-bake or an IPA dry is employed. Further, no observable changes were observed in the post-etch ULK contacted with formulations AM, AN, AO, or AU, relative to the post-etch ULK control, which suggests that organic impurities did not absorb to the ULK.

### Example 5

The etch rates of blanketed ULK, titanium nitride, Cu and W in Formulations I-L was determined. The thicknesses of the blanketed materials were measured before and after immersion in Formulations I-L at 50° C. for 65 min, unless noted otherwise. Thicknesses were determined using a 4-point probe measurement whereby the resistivity of the composition is correlated to the thickness of the film remaining and the etch rate calculated therefrom. The experimental etch rates are reported in Table 9.

TABLE 9
Etch rate of ULK, TiN, Cu and W in Å min⁻¹
after immersion in Formulations I-L.

Etch rate/Å min⁻¹

| Formulation | ULK | TiN | Cu | W |
|---|---|---|---|---|
| I | 0 | 5 (35 min) | 0 | 0 |
| J | — | 50 (35 min) | — | 0 |
| K | — | — | 0.3 | 0 |
| L | — | — | 0.1 | 0 |
| M | 0 | 13 (35 min) | 0.5 | 0 |

Importantly, it can be seen that formulations I, J and M are useful for the removal of TiN hardmask, when required.

### Example 6

The etch rates of blanketed ULK, titanium nitride, Cu and W in Formulations N—R was determined. The thicknesses of the blanketed materials were measured before and after immersion in Formulations N—R at 50° C. for 30 min. Thicknesses were determined using a 4-point probe measurement whereby the resistivity of the composition is correlated to the thickness of the film remaining and the etch rate calculated therefrom. The experimental etch rates are reported in Table 10.

TABLE 10
Etch rate of ULK, TiN, Cu and W in Å min⁻¹
after immersion in Formulations N-R.

Etch rate/Å min⁻¹

| Formulation | ULK | TiN (ΔRs) | Cu | W |
|---|---|---|---|---|
| N | 0 | 3.0 | 0 | 0 |
| O | 0 | 2.6 | 9.0 | 0 |
| P | 0 | 2.8 | 0.13 | 0 |
| Q | 0 | 2.4 | 0 | 0 |
| R | 0 | 2.2 | 0 | 0 |

Although the invention has been variously disclosed herein with reference to illustrative embodiments and features, it will be appreciated that the embodiments and features described hereinabove are not intended to limit the invention, and that other variations, modifications and other embodiments will suggest themselves to those of ordinary skill in the art, based on the disclosure herein. The invention therefore is to be broadly construed, as encompassing all such variations, modifications and alternative embodiments within the spirit and scope of the claims hereafter set forth.

1. An aqueous cleaning composition, comprising at least one etchant source, water, a source of silica, optionally at least one metal corrosion inhibitor, optionally at least one organic solvent, optionally at least one chelating agent.

2. (canceled)

3. The cleaning composition of claim 1, comprising at least one metal corrosion inhibitor and at least one organic solvent.

4. The cleaning composition of claim 1, wherein the at least one etchant comprises a fluoride species selected from the group consisting of hydrofluoric acid, fluorosilicic acid, fluoroboric acid, tetramethylammonium hexafluorophosphate, ammonium fluoride salts, ammonium bifluoride salts, ammonium fluorosilicate, tetrabutylammonium tetrafluoroborate, propylene glycol/HF, propylene glycolitetraalkylammonium fluoride, propylene glycollbenzyltrimethylammonium fluoride, and combinations thereof

5. The cleaning composition of claim 1, wherein the at least one etchant comprises fluorosilicic acid.

6. The cleaning composition of claim 1, comprising at least one organic solvent, wherein the at least one organic solvent comprises a sub-species selected from the group consisting of methanol, ethanol, isopropanol, diols, 3-chloro-1,2-propanediol, triols, 3-chloro-1-propanethiol, 1-chloro-2-propanol, 2-chloro-1-propanol, 3-chloro-1-propanol, 3-bromo-1,2-propanediol, 1-bromo-2-propanol, 3-bromo-1-propanol, 3-iodo-1-propanol, 4-chloro-1-butanol, 2-chloroethanol, dichloromethane, chloroform, acetic acid, propionic acid, trifluoroacetic acid, tetrahydrofuran (THF), N-methylpyrrolidinone (NMP), cyclohexylpyrrolidinone, N-octylpyrrolidinone, N-phenylpyrrolidinone, methyldiethanolamine, methyl formate, dimethyl formamide (DMF), dimethylsulfoxide (DMSO), tetramethylene sulfone (sulfolane), diethyl ether, phenoxy-2-propanol (PPh), propriophenone, ethyl lactate, ethyl acetate, ethyl benzoate, acetonitrile, acetone, ethylene glycol, propylene glycol, 1,3-propanediol, 1,4-propanediol, dioxane, butyryl lactone, butylene carbonate, ethylene carbonate, propylene carbonate, dipropylene glycol, diethylene glycol monomethyl ether, triethylene glycol monomethyl ether, diethylene glycol monoethyl ether, triethylene glycol monoethyl ether, ethylene glycol monopropyl ether, ethylene glycol monobutyl ether, diethylene glycol monobutyl ether, triethylene glycol monobutyl ether, ethylene glycol monohexyl ether, diethylene glycol monohexyl ether, ethylene glycol phenyl ether, propylene glycol methyl ether, dipropylene glycol methyl ether, tripropylene glycol methyl ether, dipropylene glycol dimethyl ether, dipropylene glycol ethyl ether, propylene glycol n-propyl ether, dipropylene glycol n-propyl ether (DPGPE), tripropylene glycol n-propyl ether, propylene glycol n-butyl ether, dipropylene glycol n-butyl ether, tripropylene glycol n-butyl ether, propylene glycol phenyl ether, gamma-butyrolactone, and combinations thereof.

7. The cleaning composition of claim 1, comprising at least one chelating agent, wherein the at least one chelating agent comprises a species selected from the group consisting of 1,1,1,5,5,5-hexafluoro-2,4-pentanedione (hfacH), 1,1,1-trifluoro-2,4-pentanedione (tfac), and acetylacetonate (acac), iminodiacetic acid, pyrazolates, amidinates, guanidinates, ketoimines, dienes, polyamines, ethylenediaminetetraacetic acid (EDTA), 1,2-cyclohexanediamine-N,N,N′,N′-tetraacetic acid (CDTA), etidronic acid, methanesulfonic acid, hydrochloric acid, acetic acid, alkylamines, arylamines, glycolamines, alkanolamines, triazoles, thiazoles, tetrazoles, imidazoles, 1,4-benzoquinone; 8-hydroxyquinoline; salicylidene aniline; tetrachloro-1,4-benzoquinone; 2-(2-hydroxyphenyl)-benzoxazol; 2-(2-hydroxyphenyl)-benzothiazole; hydroxyquinoline sulfonic acid (HQSA); sulfosalicylic acid (SSA); salicylic acid (SA), tetramethylammonium fluoride, tetramethylammonium chloride, tetramethylammonium bromide, tetramethylammonium iodide, pyridine, 2-ethylpyridine, 2-methoxypyridine, 3-methoxypyridine, 2-picoline, pyridine derivatives, dimethylpyridine, piperidine, piperazine, triethylamine, triethanolamine, ethylamine, methylamine, isobutylamine, tert-butylamine, tributylamine, dipropylamine, dimethylamine, diglycol amine, monoethanolamine, methyldiethanolamine, pyrrole, isoxazole, 1,2,4-triazole, bipyridine, pyrimidine, pyrazine, pyridazine, quinoline, isoquinoline, indole, imidazole, N-methylmorpholine-N-oxide (NMMO), trimethylamine-N-oxide, triethylamine-N-oxide, pyridine-N-oxide, N-ethylmorpholine-N-oxide, N-methylpyrrolidine-N-oxide, N-ethylpyrrolidine-N-oxide, 1-methylimidazole, diisopropylamine, diisobutylamine, aniline, aniline derivatives, pentamethyldiethylenetriamine, and combinations thereof.

8. The cleaning composition of claim 1, comprising at least one metal corrosion inhibitor, wherein the at least one metal corrosion inhibitor comprises a species selected from the group consisting of benzotriazole (BTA), 1,2,4-triazole (TAZ),5-aminotetrazole (ATA), 1-hydroxybenzotriazole, 5-amino-1,3,4-thiadiazol-2-thiol, 3-amino-1H-1,2,4 triazole, 3,5-diamino-1,2,4-triazole, tolyltriazole, 5-phenyl-benzotriazole, 5-nitro-benzotriazole, 3-amino-5-mercapto-1,2,4-triazole, 1-amino-1,2,4-triazole, 2-(5-amino-pentyl)-benzotriazole, 1-amino-1,2,3-triazole, 1-amino-5-methyl-1,2,3-triazole, 3-mercapto-1,2,4-triazole, 3-isopropyl-1,2,4-triazole, 5-phenylthiol-benzotriazole, halo-benzotriazoles (halo=F, Cl, Br, I), naphthotriazole, 1H-tetrazole-5-acetic acid, 2-mercaptobenzothiazole (2-MBT), 1-phenyl-2-tetrazoline-5-thione, 2-mercaptobenzimidazole (2-MBI), 4-methyl-2-phenylimidazole, 2-mercaptothiazoline, 2,4-diamino-6-methyl-1,3,5-triazine, thiazole, imidazole, benzimidazole, triazine, methyltetrazole, Bismuthiol 1,1,3-dimethyl-2-imidazolidinone, 1,5-pentamethylenetetrazole, 1-phenyl-5-mercaptotetrazole, diaminomethyltriazine, imidazoline thione, 4-methyl-4H-1,2,4-triazole-3-thiol, 5-amino-1,3,4-thiadiazole-2-thiol, benzothiazole, tritolyl phosphate, indazole, adenine, cytosine, guanine, thymine, phosphate inhibitors, amines, pyrazoles, propanethiol, silanes, secondary amines, benzohydroxamic acids, heterocyclic nitrogen inhibitors, citric acid, ascorbic acid, thiourea, 1,1,3,3-tetramethylurea, urea, urea derivatives, uric acid, potassium ethylxanthate, glycine, iminodiacetic acid, acid, boric acid, malonic acid, succinic acid, nitrilotriacetic acid, sulfolane, 2,3,5-trimethylpyrazine, 2-ethyl-3,5-dimethylpyrazine, quinoxaline, acetyl pyrrole, pyridazine, histadine, pyrazine, glutathione (reduced), cysteine, cystine, thiophene, mercapto pyridine N-oxide, thiamine HCl, tetraethyl thiuram disulfide, 2,5-dimercapto-1,3-thiadiazoleascorbic acid, ascorbic acid, and combinations thereof

9. The cleaning composition of claim 1, wherein the source of silica comprises TEOS.

10. The cleaning composition of claim 1, wherein said composition further comprises post-plasma etch residue selected from the group consisting of titanium-containing residue, polymeric-residue, copper-containing residue, tungsten-containing residue, cobalt-containing residue, and combinations thereof.

11. The cleaning composition of claim 1, wherein the source of silica comprises a tetraalkoxysilane compound.

12. The cleaning composition of claim 1, comprising at least one organic solvent, at least one etchant, a source of silica, at least one corrosion inhibitor, and water, wherein the weight percent ratios of the organic solvent(s) relative to etchant(s) is about 3 to about 7, the water relative to etchant(s) is about 88 to about 93, the source of silica relative to etchant(s) is about 0.1 to about 0.5, and the corrosion inhibitor(s) relative to etchant(s) is about 1 to about 4.

13. The cleaning composition of claim 1, wherein the at least one etchant comprises ammonium fluorosilicate.

14. The cleaning composition of claim 1, wherein the pH is in a range from about 0 to about 5.

15. The cleaning composition of claim 1, wherein the composition comprises fluorosilicic acid and TEOS.

16. The cleaning composition of claim 1, wherein said aqueous cleaning composition is suitable for cleaning post-plasma etch residue from a microelectronic device having said residue thereon.

17.-21. (canceled)

22. A method of removing material from a microelectronic device having said material thereon, said method comprising contacting the microelectronic device with an aqueous cleaning composition for sufficient time to at least partially remove said material from the microelectronic device, wherein the aqueous cleaning composition includes at least one etchant, water, a source of silica, optionally at least one metal corrosion inhibitor, optionally at least one organic solvent, optionally at least one chelating agent.

23. (canceled)

24. The method of claim 22, comprising at least one metal corrosion inhibitor and at least one organic solvent.

25. The method of claim 22, wherein the source of silica comprises a tetraalkoxysilane compound.

26. (canceled)

27.-30. (canceled)

31. The method of claim 22, wherein said composition further comprises post-plasma etch residue selected from the group consisting of titanium-containing residue, polymeric-residue, copper-containing residue, tungsten-containing residue, cobalt-containing residue, and combinations thereof.

32. (canceled)

33. (canceled)
